(19) United States
(12) Patent Application Publication
(10) Pub. No.: US 2022/0390783 A1
(43) Pub. Date: Dec. 8, 2022

(54) TRANSISTOR ARRAY SUBSTRATE, METHOD OF PRODUCING TRANSISTOR ARRAY SUBSTRATE, LIQUID CRYSTAL DISPLAY DEVICE, AND ELECTRONIC APPARATUS

(71) Applicants: SONY GROUP CORPORATION, Tokyo (JP); SONY SEMICONDUCTOR SOLUTIONS CORPORATION, Kanagawa (JP)

(72) Inventors: KOICHI AMARI, TOKYO (JP); KOICHI NAGASAWA, TOKYO (JP); HITOSHI TSUNO, TOKYO (JP); YOSHIHIKO KAJIYA, TOKYO (JP); SHINTARO NAKANO, TOKYO (JP); TSUYOSHI OKAZAKI, TOKYO (JP); AKIKO TORIYAMA, TOKYO (JP); YOSHITAKA YAGI, TOKYO (JP); KEIICHI MAEDA, KANAGAWA (JP); TAKASHI SAKAIRI, KANAGAWA (JP); TSUTOMU TANAKA, KANAGAWA (JP)

(21) Appl. No.: 17/774,904

(22) PCT Filed: Oct. 19, 2020
(86) PCT No.: PCT/JP2020/039295

§ 371 Date: May 6, 2022

(30) Foreign Application Priority Data
Nov. 15, 2019 (JP) 2019-206977

(51) Int. Cl. G02F 1/1368; G02F 1/1362

(52) U.S. Cl. CPC G02F 1/1368; G02F 1/136295

(57) ABSTRACT

It is an object of the present disclosure to dispose an optical element on a lower surface side of transistors without being influenced by heat treatment in a transistor forming process such that peeling, displacement, and the like do not easily occur. A transistor array substrate includes: a first substrate (110) including transistors (113) arranged in an array; and a second substrate (120) including an optical element (122), in which the transistors are arranged on a front surface side of the first substrate, and the second substrate is bonded to a back surface of the first substrate by plasma bonding treatment.

### TECHNICAL FIELD

The present disclosure relates to a transistor array substrate, a method of producing the transistor array substrate, a liquid crystal display device, and an electronic apparatus.

### BACKGROUND ART

A display device including a transistor array substrate in which transistors as switching elements are arranged in a matrix and a counter substrate disposed to face the transistor array substrate has been known. For example, a liquid crystal display device having a configuration in which a liquid crystal material layer is sandwiched between a transistor array substrate and a counter substrate displays an image by operating a pixel as an optical shutter (light valve). In recent years, liquid crystal display devices are desired to have high definition and high luminance. For this reason, efforts are being made to improve the aperture ratio of pixels by miniaturizing patterns.

In an active matrix type liquid crystal display device, a voltage is applied to a pixel via a switching element and then the switching element is made in a non-conductive state. Then, a capacitive structure (capacity unit) of the pixel holds the voltage to perform display. Here, when light enters the transistor part as a switching element, a leak current flows and the voltage of the capacity unit changes, resulting in deterioration of image quality. For this reason, a method of reducing the leakage by shielding the transistor has been known (see, for example, Patent Literature 1). In the transistor array substrate, it is necessary to provide a shading part on the upper surface side and the back surface side of the transistor to prevent light from entering the transistor. Usually, a wiring or an electrode used in a pixel circuit often function also as a shading part.

### CITATION LIST

### Patent Literature

Patent Literature 1 Japanese Patent Application Laid-open No. 2004-45576

### DISCLOSURE OF INVENTION

### Technical Problem

In the case of performing a step of forming a transistor after forming a shading part on the back surface side and then forming a shading part on the upper surface side on a layer including the transistor, the shading part on the back surface side is exposed to a high-temperature process when forming the transistor. Therefore, the shading part on the back surface side needs to be formed using a material capable of withstanding heat treatment(e.g., the maximum temperature is approximately 1000° C.) in the transistor forming process. Under such conditions, for example, the shading part needs to be formed using a material having a high melting point, such as tungsten silicide (WSi).

However, even if tungsten silicide is used, there is a problem that exposure to high temperature deteriorates the film quality and reduces the light-shielding property. In a transmissive liquid crystal display device using a transistor array substrate that includes such a shading part, strong incident light from a light source cannot be sufficiently shielded by the shading part on the back surface side. Therefore, it is necessary to use the shading part side of the upper surface as the light source side, which limits the layout and the like. Further, if optical elements such as an optical compensation plate and a microlens can be formed as in-cell elements on the back surface side of the transistor, it is possible to improve the luminance and contrast at low cost. However, it is difficult to make these optical elements so as to withstand the heat treatment in the transistor forming process. It is also conceivable that another substrate including optical elements such as an optical compensation plate and a microlens is bonded with an adhesive, but there is a concern that peeling or displacement due to exposure to light from the light source occurs.

Therefore, it is an object of the present disclosure to provide a transistor array substrate in which an optical element including a shading part, an optical compensation plate, a microlens, and the like can be disposed on a lower surface side of transistors without being influenced by heat treatment in a transistor forming process such that peeling, displacement, and the like do not easily occur, a method of producing the transistor array substrate, a display device including the transistor array substrate, and an electronic apparatus including the display device.

### Solution to Problem

A transistor array substrate according to the present disclosure for achieving the above-mentioned object is a transistor array substrate, including:

a first substrate that includes transistors arranged in an array; and

a second substrate that includes an optical element, in which

the transistors are arranged on a front surface side of the first substrate, and

the second substrate is bonded to a back surface of the first substrate by plasma bonding treatment.

A method of producing a transistor array substrate according to the present disclosure for achieving the above-mentioned object is a method of producing a transistor array substrate, including the following steps of:

forming transistors arranged in an array on a front surface of a first substrate;

forming a second substrate that includes an optical element; and

bonding, by plasma bonding treatment, the second substrate to a back surface of the first substrate that includes the transistors arranged in an array.

A liquid crystal display device according to the present disclosure for achieving the above-mentioned object is a liquid crystal display device, including:

a transistor array substrate;

a counter substrate disposed to face the transistor array substrate, and

a liquid crystal material layer enclosed between the transistor array substrate and the counter substrate, in which

the transistor array substrate includes a first substrate that includes transistors arranged in an array and a second substrate that includes an optical element,

the transistors are arranged on a front surface side of the first substrate, and

the second substrate is bonded to a back surface of the first substrate by plasma bonding treatment.

An electronic apparatus according to the present disclosure for achieving the above-mentioned object is an electronic apparatus, including:

a liquid crystal display device that includes
a transistor array substrate,
a counter substrate disposed to face the transistor array substrate, and
a liquid crystal material layer enclosed between the transistor array substrate and the counter substrate, in which

the transistor array substrate includes a first substrate that includes transistors arranged in an array and a second substrate that includes an optical element,

the transistors are arranged on a front surface side of the first substrate, and

the second substrate is bonded to a back surface of the first substrate by plasma bonding treatment.

### BRIEF DESCRIPTION OF DRAWINGS

FIG. 1 is a schematic diagram describing a liquid crystal display device using a transistor array substrate according to the present disclosure.

FIG. 2A is a schematic cross-sectional view describing a basic configuration of the liquid crystal display device. FIG. 2B is a schematic circuit diagram describing a pixel in the liquid crystal display device.

FIG. 3 is a schematic partial cross-sectional view describing a liquid crystal display device according to the present disclosure.

FIG. 4A and FIG. 4B are each a schematic partial cross-sectional view describing a method of producing a transistor array substrate.

FIG. 5A and FIG. 5B are each a schematic partial plan view describing the method of producing a transistor array substrate, following FIG. 4B.

FIGS. 6A and 6B are each a schematic partial plan view describing the method of producing a transistor array substrate, following FIG. 5B.

FIG. 7 is a schematic partial plan view describing the method of producing a transistor array substrate, following FIG. 6B.

FIG. 8 is a schematic partial plan view describing the method of producing a transistor array substrate, following FIG. 7.

FIG. 9 is a schematic partial plan view describing the method of producing a transistor array substrate, following FIG. 8.

FIG. 10 is a schematic partial cross-sectional view describing a liquid crystal display device using a transistor array substrate according to a first modified example.

FIG. 11 is a schematic diagram describing the effect of optical compensation by tilting a C-plate.

FIG. 12A is a schematic perspective view describing a blazed structure in which the cross section of the lattice groove is serrated. FIG. 12B is a schematic partial cross-sectional view describing an optical element including an optical compensation film formed on the blazed structure.

FIG. 13A and FIG. 13B are each a schematic partial plan view describing the method of producing a transistor array substrate.

FIG. 14A and FIG. 14B are each a schematic partial plan view describing the method of producing a transistor array substrate, following FIG. 13B.

FIG. 15 is a schematic partial plan view describing the method of producing a transistor array substrate, following FIG. 14B.

FIG. 16 is a schematic partial cross-sectional view describing a liquid crystal display device using a transistor array substrate according to a second modified example.

FIG. 17A and FIG. 17B are each a schematic partial plan view describing the method of producing a transistor array substrate.

FIG. 18A and FIG. 18B are each a schematic partial plan view describing the method of producing a transistor array substrate, following FIG. 17B.

FIG. 19 is a schematic partial plan view describing the method of producing a transistor array substrate, following FIG. 18B.

FIG. 20 is a schematic partial cross-sectional view describing a liquid crystal display device using a transistor array substrate according to a third modified example.

FIG. 21 is a schematic partial plan view describing the lamination relationship of the transistor array substrate.

FIG. 22 is a schematic partial plan view describing the lamination relationship of the transistor array substrate, following FIG. 21.

FIG. 23 is a schematic partial plan view describing the lamination relationship of the transistor array substrate, following FIG. 22.

FIG. 24 is a schematic partial plan view describing the lamination relationship of the transistor array substrate, following FIG. 23.

FIG. 25A and FIG. 25B are each a schematic partial plan view describing the method of producing a transistor array substrate.

FIG. 26A, FIG. 26B, and FIG. 26C are each a schematic partial plan view describing the method of producing a transistor array substrate, following FIG. 25B.

FIG. 27A and FIG. 27B are each a schematic partial plan view describing the method of producing a transistor array substrate, following FIG. 26B.

FIG. 28 is a schematic partial plan view describing the method of producing a transistor array substrate, following FIG. 27B.

FIG. 29 is a schematic partial cross-sectional view describing a liquid crystal display device using a transistor array substrate according to a fourth modified example.

FIG. 30 is a schematic partial plan view describing the lamination relationship of the transistor array substrate.

FIG. 31A and FIG. 31B are each a schematic partial plan view describing the method of producing a transistor array substrate.

FIG. 32A, FIG. 32B, and FIG. 32C are each a schematic partial plan view describing the method of producing a transistor array substrate, following FIG. 31B.

FIG. 33 is a schematic partial plan view describing the method of producing a transistor array substrate, following FIG. 32B.

FIG. 34 is a schematic partial cross-sectional view describing a liquid crystal display device using a transistor array substrate according to a fifth modified example.

FIG. 35 is a conceptual diagram of a projection type display device.

FIG. 36 is a block diagram depicting an example of schematic configuration of a vehicle control system.

FIG. 37 is a diagram of assistance in explaining an example of installation positions of an outside-vehicle information detecting section and an imaging section.

### MODE(S) FOR CARRYING OUT THE INVENTION

Hereinafter, the present disclosure will be described on the basis of embodiments with reference to the drawings. The present disclosure is not limited to the embodiments, and various numerical values and materials in the embodiments are examples. In the following description, the same elements or elements having the same function will be denoted by the same reference symbols and duplicate description will be omitted. Note that description will be made in the following order.

1. Transistor array substrate, method of producing a transistor array substrate, liquid crystal display device, and electronic apparatus according to present disclosure, and general description

2. First Embodiment

3. First modified example

4. Second modified example

5. Third modified example

6. Fourth modified example

7. Fifth modified example

8. Description of electronic apparatus, and others

[Transistor Array Substrate, Method of Producing a Transistor Array Substrate, Liquid Crystal Display Device, and Electronic Apparatus According to Present Disclosure, and General Description]

In the following description, a transistor array substrate according to the present disclosure, a transistor array substrate obtained by a method of producing a transistor array substrate according to the present disclosure, a transistor array substrate used in a liquid crystal display device according to the present disclosure, and a transistor array substrate used in a liquid crystal display device included in an electronic apparatus according to the present disclosure will be referred to simply as [the transistor array substrate according to the present disclosure].

As described above, a transistor array substrate according to the present disclosure includes:

a first substrate that includes transistors arranged in an array; and

a second substrate that includes an optical element, in which

the transistors are arranged on a front surface side of the first substrate, and

the second substrate is bonded to a back surface of the first substrate by plasma bonding treatment.

In the transistor array substrate according to the present disclosure, an oxide film on a side of the first substrate and an oxide film on a side of the second substrate may be bonded to each other by plasma bonding treatment

Alternatively, a metal wiring on a side of the first substrate and a metal wiring on a side of the second substrate may be bonded to each other by plasma bonding treatment. In this case, a copper wiring on a side of the first substrate and a copper wiring on a side of the second substrate may be bonded to each other by plasma bonding treatment.

In the transistor array substrate according to the present disclosure including the above-mentioned various favorable configurations, at least one of a microlens and an optical compensation element may be formed as the optical element of the second substrate. In this case, the optical compensation element may include a laminated film having a blazed structure.

Alternatively, the optical element of the second substrate may be a shading part disposed to be located on the back surface of the transistors. In this case, a contact that connects the shading part of the second substrate and a gate electrode of the transistor of the first substrate to each other may be provided. The contact may be formed using a via hole provided from a side of a surface opposite to a bonding surface in the second substrate. Alternatively, the contact may be formed using a via hole provided from a side of a bonding surface in the first substrate.

In the transistor array substrate according to the present disclosure including the above-mentioned various favorable configurations, the shading part may be formed using copper, aluminum, tungsten, or an alloy thereof. Examples of the alloy include AlSi, AlCu, and WSi. Here, copper has the advantage of low resistivity, but the light-shielding performance thereof is not necessarily high as compared with other metals. In this regard, the shading part may include a wiring in which copper and a metal different from copper are laminated to improve the light-shielding property. In this case, the shading part favorably includes a wiring in which copper and aluminum are laminated or a wiring in which copper and tungsten are laminated.

In the transistor array substrate according to the present disclosure including the above-mentioned various favorable configurations, another substrate is further bonded to at least one of a side of the first substrate and a side of the second substrate by plasma bonding treatment. For example, a substrate on which a driver circuit or the like is mounted can be incorporated on a side of the second substrate.

The transistor array substrate according to the present disclosure including the above-mentioned various favorable configurations may further include: a capacitive structure (capacity unit) that holds a pixel voltage supplied via the transistor as the switching element; and a pixel electrode to which the pixel voltage held by the capacitive structure is applied. The capacitive structure may be disposed between the transistor and the wiring layer. Alternatively, the transistor array substrate may include a plurality of wiring layers and the capacitive structure may be disposed between the wiring layer and the wiring layer.

In the case of a transistor array substrate used in a transmissive liquid crystal display device, a pixel electrode can be formed using a transparent conductive material such as indium tin oxide (ITO) and indium zinc oxide (IZO). In the case of a transistor array substrate used in a reflective liquid crystal display device, a pixel electrode can be formed by using a metal such as aluminum (Al) and silver (Ag) or a metal material such as an alloy thereof. Note that the pixel electrode can be formed by laminating the above-mentioned transparent conductive material and these metal materials in some cases.

In the transistor array substrate according to the present disclosure including the above-mentioned various favorable configurations, the transistor may be disposed above a scan line and the transistor is surrounded by a wall-shaped lateral light-shielding film that extends in the normal direction with respect to the substrate.

In an active matrix type liquid crystal display device, a voltage is applied to a pixel via a switching element and then the switching element is made in a non-conductive state. Then, a capacitive structure of the pixel holds the voltage to perform display. Therefore, when light enters the switching element that should be in a non-conductive state and a leak current flows, the voltage changes, resulting in deterioration of display quality. By shielding light from the transistor, it is possible to reduce the leakage.

As described above, a liquid crystal display device according to the present disclosure and a liquid crystal display device used in an electronic apparatus according to the present disclosure (hereinafter, referred to simply as [the liquid crystal display device according to the present disclosure] in some cases) each include

a transistor array substrate;

a counter substrate disposed to face the transistor array substrate; and

a liquid crystal material layer enclosed between the transistor array substrate and the counter substrate. The electronic apparatus according to the present disclosure may further include a light source disposed on a side of the second substrate.

As the counter substrate, a substrate formed of a transparent material such as quarts glass can be used. A counter electrode can be formed on the counter substrate using a transparent conductive material such as indium tin oxide (ITO) and indium zinc oxide (IZO). The counter electrode functions as a common electrode for the respective pixels of the liquid crystal display device.

As the first substrate constituting the transistor array substrate or a support used as the second substrate, a substrate formed of a transparent material such as quarts glass or a substrate formed of a semiconductor material such as silicon can be used. The transistor constituting the switching element can be formed by, for example, forming a semiconductor material layer and the like on a substrate and processing them.

The material forming various wirings, electrodes, or contacts are not particularly limited as long as implementation of the present disclosure is note interfered. For example, a metal material such as copper (Cu), aluminum (Al), an aluminum alloy such as AlCu and AlSi, tungsten (W), and a tungsten alloy such as tungsten silicide (WSi) can be used.

The material forming an insulation layer, an insulation film, and the like is not particularly limited, and inorganic materials such as a silicon oxide, a silicon oxynitride, and a silicon nitride and organic materials such as polyimide can be used.

The deposition method for a semiconductor material layer, a wiring, an electrode, an insulation layer, an insulation film, and the like is not particularly limited, and deposition can be performed using a well-known deposition method as long as implementation of the present disclosure is not interfered. The same applies to the patterning method for these.

The liquid crystal display device may be configured to display a monochrome image or a color image. As the pixel value of the liquid crystal display device, some image resolutions such as (3840,2160) and (7680,4320) in addition to U-XGA (1600,1200), HD-TV (1920,1080), and Q-XGA (2048,1536) can be exemplified, but the present disclosure is not limited to these values.

Further, as an electronic apparatus including the liquid crystal display device according to the present disclosure, various electronic apparatuses having an image display function can be exemplified in addition to a direct-view or projection type display device.

The various conditions in the present specification are satisfied not only in the case where they are strictly satisfied but also in the case where they are substantially satisfied. The presence of various design or manufacturing variations is acceptable. Further, the drawings used in the following description are schematic and do not show the actual dimensions or the ratio thereof.

### First Embodiment

A first embodiment relates to a transistor array substrate, a method of producing a transistor array substrate, a liquid crystal display device, and an electronic apparatus according to the present disclosure.

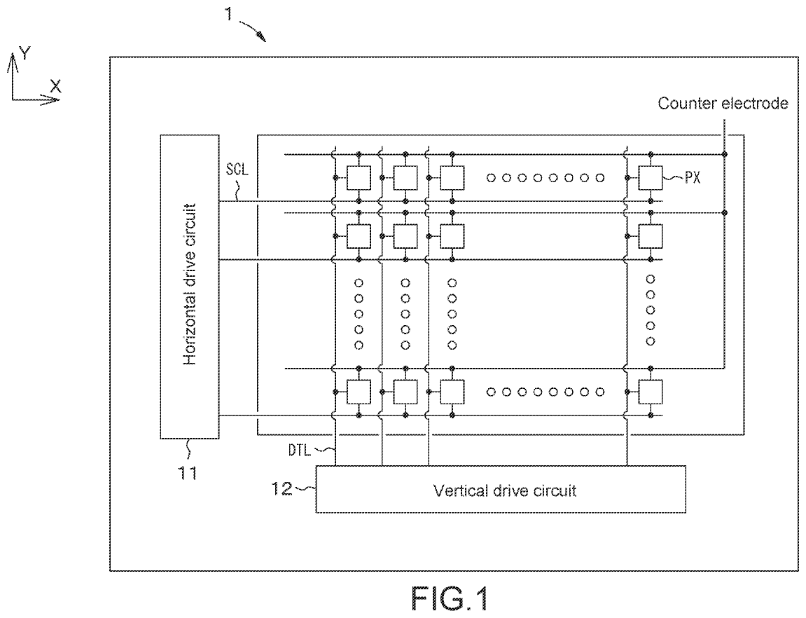

FIG. 1 is a schematic diagram describing a liquid crystal display device using a transistor array substrate according to a first embodiment of the present disclosure.

The liquid crystal display device according to the first embodiment is an active matrix type liquid crystal display device. As shown in FIG. 1, a liquid crystal display device 1 includes pixels PX arranged in a matrix and various circuits such as a horizontal drive circuit 11 and a vertical drive circuit 12 for driving the pixels PX. The reference symbol SCL indicates a scan line for scanning the pixels PX and the reference symbol DTL indicates a signal line for supplying various voltages to the pixels PX. For example, M pixels PX are arranged in the horizontal direction, N pixels PX are arranged in the vertical direction, and thus, the total M×N pixels PX are arranged in a matrix. The counter electrode shown in FIG. 1 is provided as a common electrode for the respective liquid crystal cells. Note that although the horizontal drive circuit 11 and the vertical drive circuit 12 are arranged on one end side of the liquid crystal display device 1 in the example shown in FIG. 1, this is merely an example.

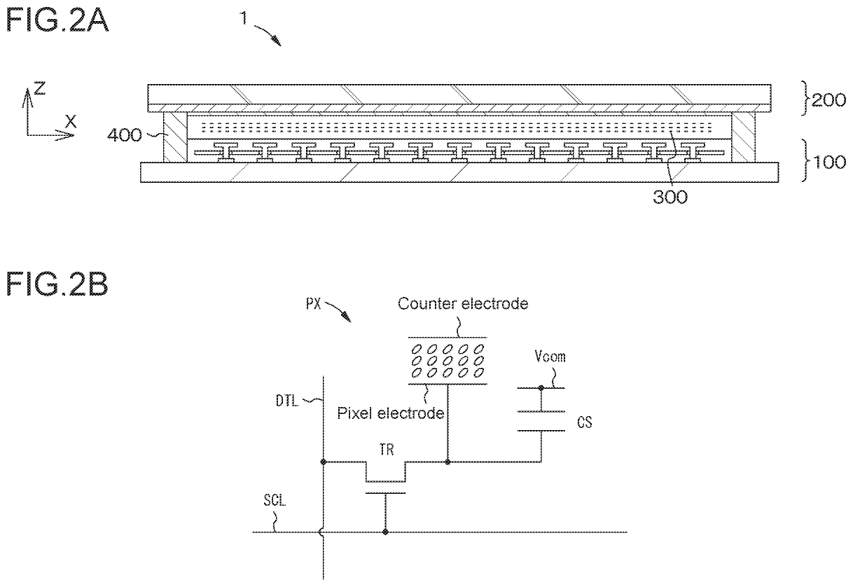

FIG. 2A is a schematic cross-sectional view describing a basic configuration of the liquid crystal display device. FIG. 2B is a schematic circuit diagram describing a pixel in the liquid crystal display device.

As shown in FIG. 2A, the liquid crystal display device 1 includes:

a transistor array substrate 100;

a counter substrate 200 disposed to face the transistor array substrate; and

a liquid crystal material layer 300 enclosed between the transistor array substrate and the counter substrate. The transistor array substrate 100 and the counter substrate 200 are sealed by a seal part 400. The seal part 400 has an annular shape surrounding the liquid crystal material layer 300.

As described below, the transistor array substrate 100 is configured by laminating various components on a substrate, for example. The liquid crystal display device 1 is, for example, a transmissive liquid crystal display device used in a projector.

A counter electrode formed of a transparent conductive material such as ITO is provided on the counter substrate 200. More specifically, the counter substrate 200 includes, for example, a substrate that is formed of transparent glass and has a rectangular shape, a counter electrode provided on the surface of the substrate on the side of the liquid crystal material layer 300, an oriented film provided on the counter electrode, and the like. Further, a polarizing plate, an oriented film, or the like is appropriately provided on the transistor array substrate 100 and the counter substrate 200. Note that for convenience of illustration, the transistor array substrate 100 and the counter substrate 200 in FIG. 2A are shown in a simplified manner.

As shown in FIG. 2B, the liquid crystal cell constituting the pixel PX includes a pixel electrode provided on the transistor array substrate 100, a liquid crystal material layer of a portion corresponding to the pixel electrode, and a counter electrode. In order to prevent the liquid crystal material layer 300 from deteriorating, a common potential V_{com} of a positive polarity or a negative polarity is alternately applied to the counter electrode when the liquid crystal display device 1 is driven. Note that the respective elements of the pixel PX excluding the liquid crystal material layer and the counter electrode are formed in the transistor array substrate 100 shown in FIG. 2A.

As is clear from the wiring relationship in FIG. 2B, a pixel voltage supplied from a signal line DTL is applied to the pixel electrode via a transistor TR made in conductive state by a scanning signal of a scan line SCL. Since the pixel electrode and one electrode of a capacitive structure CS is conducted, the pixel voltage is applied also to the one electrode of the capacitive structure CS. Note that the common potential V_{com} is applied to the other electrode of the capacitive structure CS. In this configuration, even after the transistor TR is made a non-conductive state, the voltage of the pixel electrode is held by the capacitance of the liquid crystal cell and the capacitive structure CS.

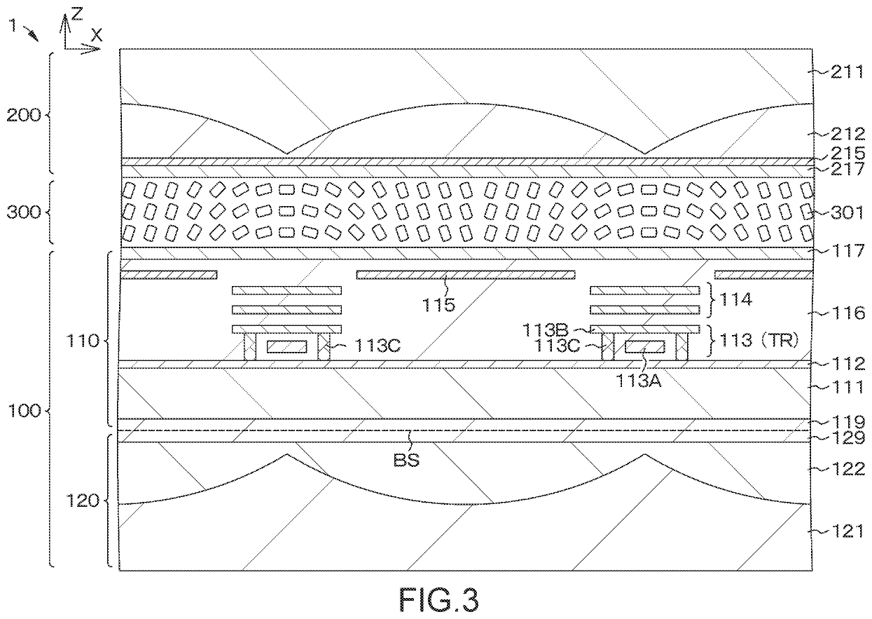

As will be described in detail with reference to FIG. 3 to FIG. 9, in the display device 1 according to the first embodiment, the transistor array substrate 100 includes a first substrate that includes transistors arranged in an array and a second substrate that includes an optical element. Then, the transistors are arranged on a front surface side of the first substrate, and the second substrate is bonded to a back surface of the first substrate by plasma bonding treatment.

FIG. 3 is a schematic partial cross-sectional view describing a liquid crystal display device according to the present disclosure.

The transistor array substrate 100 includes a first substrate 110 including transistors 113 arranged in an array, and a second substrate 120 including an optical element 122. More specifically, a microlens is formed as the optical element 122 of the second substrate. Note that for convenience of description, the microlens as the optical element 122 is referred to simply as [the microlens 122] in some cases. The same applies to other components.

The transistor 113 corresponds to the transistor TR shown in FIG. 2B, and the transistors 113 are arranged on the front surface side of the first substrate 110. The second substrate 120 is bonded to the back surface of the first substrate 110 by plasma bonding treatment. The reference symbol BS indicates the bonding surface between the first substrate 110 and the second substrate 120. An oriented film 117 is disposed on the surface of the transistor array substrate 100 on the side of the liquid crystal material layer 300.

The counter substrate 200 includes a support 211 formed of quartz glass, and an optical element 212, a common electrode 215, and an oriented film 217 sequentially laminated thereon. The microlens forming the optical element 212 is disposed at a position corresponding to the corresponding pixel electrode 115. The liquid crystal material layer 300 is disposed so as to be sandwiched between the oriented film 117 and the oriented film 217. The initial orientation state of liquid crystal molecules 301 is defined by these. The oriented films 117 and 217 can be formed as, for example, an inorganic oriented film formed by orthorhombic vapor deposition.

First, respective elements constituting the first substrate 110 will be described.

A wiring layer 116 that includes a scan line 112, the transistors 113, a wiring 114 including a data line, a common potential line, and the like, the pixel electrode 115 formed of a transparent conductive material, and the like is formed on a support 111 formed of quartz glass. Although the wiring layer 116 is formed by appropriately patterning and laminating various material layers, but is shown in a simplified manner for convenience of illustration. The oriented film 117 for defining the initial orientation state of liquid crystal molecules in the liquid crystal material layer 300 is disposed on the wiring layer 116. Further, an oxide film 119 for bonding is formed on the surface of the support 111 on the side of the second substrate 120.

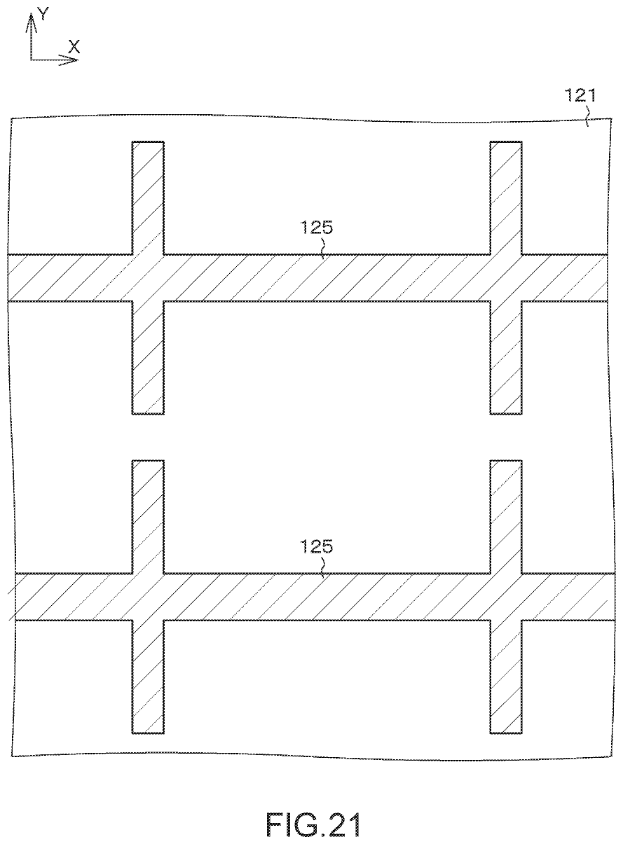

The scan line 112 is basically formed so as to extend in the x direction, and has a shape including a branch wiring extending in the Y direction. The planar shape of the scan line 112 is a shape similar to that of a portion indicated by the reference symbol 125 with hatching in FIG. 21 although it is a figure referring to a modified example described below.

An interlayer insulating film is formed on the entire surface including the scan line 112, and the transistors 113 each including a semiconductor material layer 113A patterned in an island shape and a gate electrode 113B are arranged thereon. The transistors 113 are provided corresponding to the respective pixels PX shown in FIG. 1 and are arranged in an array. The gate electrode 113B is connected to the scan line 112 via a contact 113C.

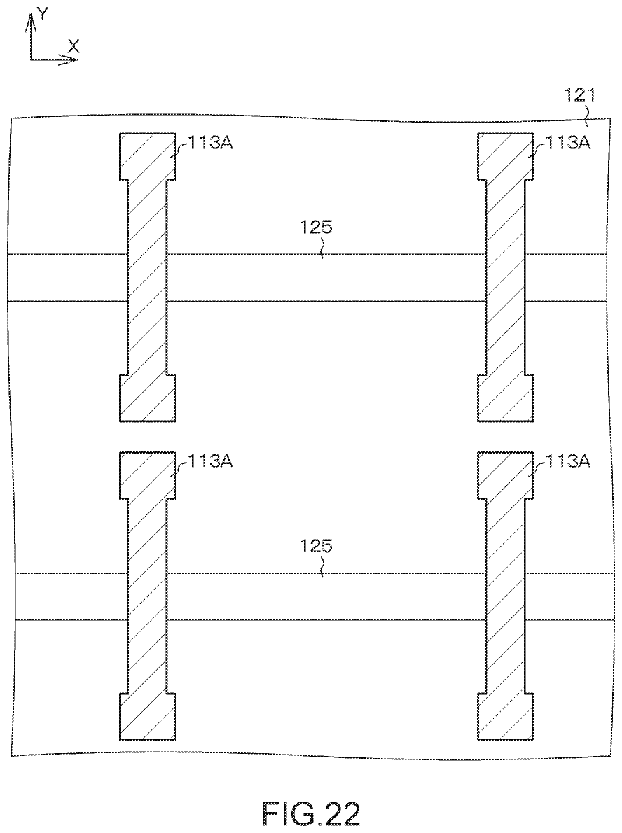

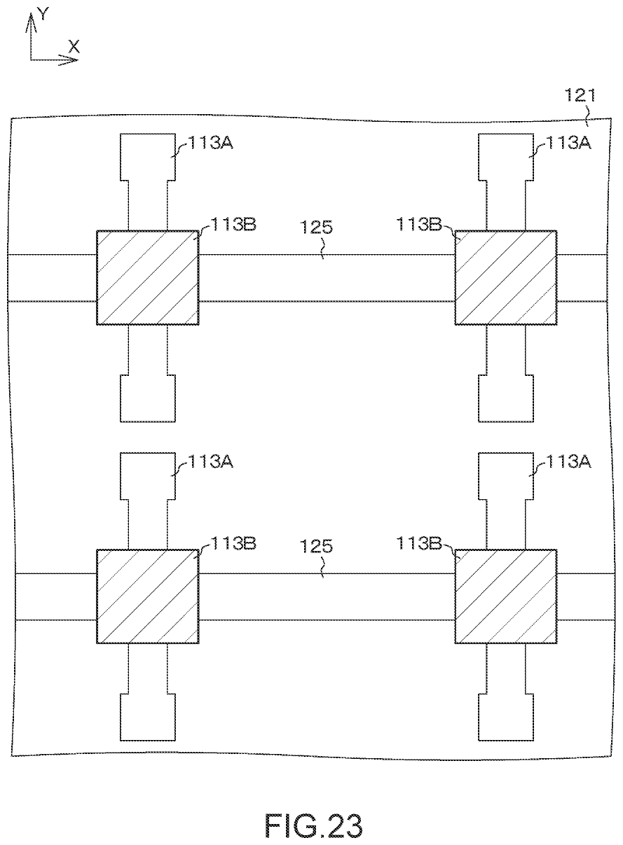

The semiconductor material layer 113A patterned in an island shape is formed so as to extend in the direction perpendicular to the paper surface (i.e., the Y direction), and both ends thereof correspond to one pair of source/drain regions. The gate electrode 113B is formed in an island shape so as to overlap with the channel forming region of the semiconductor material layer 113A. The planar shape of the semiconductor material layer 113A is a shape similar to that of a portion with hatching in FIG. 22 and the planar shape of the gate electrode 113B is a shape similar to that of a portion with hatching in FIG. 23 although they are diagrams of a modified example described below.

The wiring 114 includes a data line and a common potential line that are formed so as to extend in the Y direction, an electrode having an island shape constituting a capacity unit, and the like. The wiring 114 is disposed between adjacent pixel electrodes 115, and constitutes a shading part on the side of the first substrate 110. Although not shown in FIG. 3, a data line is connected to one source/drain region of the semiconductor material layer 113A, and the electrode of the capacity unit and the pixel electrode 115 are connected to the other source/drain region.

The respective elements constituting the first substrate 110 have been described above. Subsequently, the respective elements constituting the second substrate 120 will be described.

The microlens 122 formed of a material having a refractive index higher than that of quartz glass is formed on a support 121 formed of quartz glass, and an oxide film 129 for bonding is formed thereon. The microlens 122 is disposed at a position corresponding to the corresponding pixel electrode 115.

In the case where light from a light source is incident from the side of the first substrate 100, the light is converged by the microlens 122 to reach the liquid crystal material layer 300. As a result, since the components of light blocked by the wiring 114 or the like can be reduced, it is possible to increase the luminance of an image to be displayed. The emission direction of the light that is transmitted through the liquid crystal material layer 300 and is emitted from the counter substrate 200 is adjusted by the optical element 212 including a microlens provided on the counter substrate 200. Note that in the case where light from a light source is incident from the side of the counter substrate 200, the light is converged by the microlens 212 and the emission direction is adjusted by the microlens 122.

The oxide film 119 in the first substrate 110 and the oxide film 129 in the second substrate 120 are flattened by, for example, CMP and then plasma-bonded. The reference symbol BS indicates the bonding surface. In the transistor array substrate 100, the oxide film 119 on the side of the first substrate 110 and the oxide film 129 on the side of the second substrate 120 are bonded to each other by plasma bonding treatment.

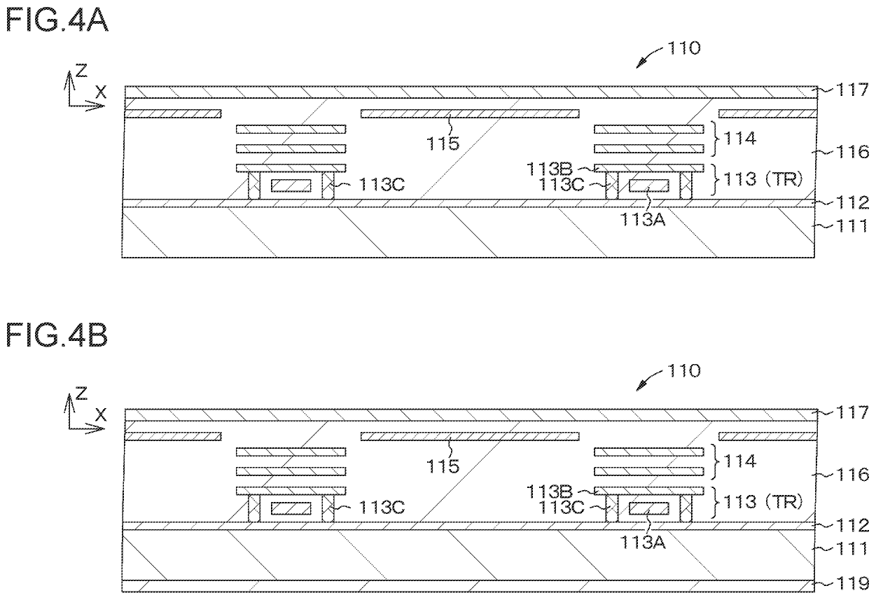

As will be described below in detail with reference to FIG. 4 to FIG. 9, the plasma bonding is performed after a transistor forming process on the side of the first substrate 110 is finished. Heat treatment on the second substrate 120 is limited to one associated with annealing treatment after bonding, or the like. The optical element 122 of the second substrate 120 is not exposed to heat treatment of approximately 1000° C. necessary for a transistor forming process. Therefore, the degree of freedom in selection of the material forming the optical element 122 increases. For example, a resin-based high-refractive index material or the like can also be used.

Subsequently, a method of producing the transistor array substrate 100 will be described.

The method of producing the transistor array substrate 100 includes the steps of:

forming transistors arranged in an array on a front surface of the first substrate 110;

forming the second substrate 120 including the optical element 122; and

bonding, by plasma bonding treatment, the second substrate 120 to a back surface of the first substrate 110 that includes the transistors arranged in an array.

FIG. 4 to FIG. 9 are each a schematic partial plan view describing the method of producing a transistor array substrate. Hereinafter, the method of producing the transistor array substrate 100 will be described in detail with reference to these figures.

[Step-100]

(See FIG. 4A and FIG. 4B)

First, a step of forming transistors arranged in an array on the front surface of the first substrate 110 is performed. Specifically, the support 111 is prepared, and the transistors 113 arranged in an array are formed thereon by a well-known deposition method or pattering method. More specifically, the scan line 112 is formed on the front surface of the support 111, and then, the transistors 113 arranged in an array are formed. Further, the wiring layer 116 including the wiring 114 and the pixel electrode 115 is formed, and the oriented film 117 is formed thereon (see FIG. 4A).

Subsequently, the oxide film 119 for bonding is formed on the back surface of the support 111. For example, a silicon oxide film is deposited by a plasma CVD method using TEOS and then polished by CMP to form the oxide film 119 (see FIG. 4B). By reducing the surface roughness of the oxide film 119, it is possible to improve the bondability at the time of plasma bonding.

[Step-110]

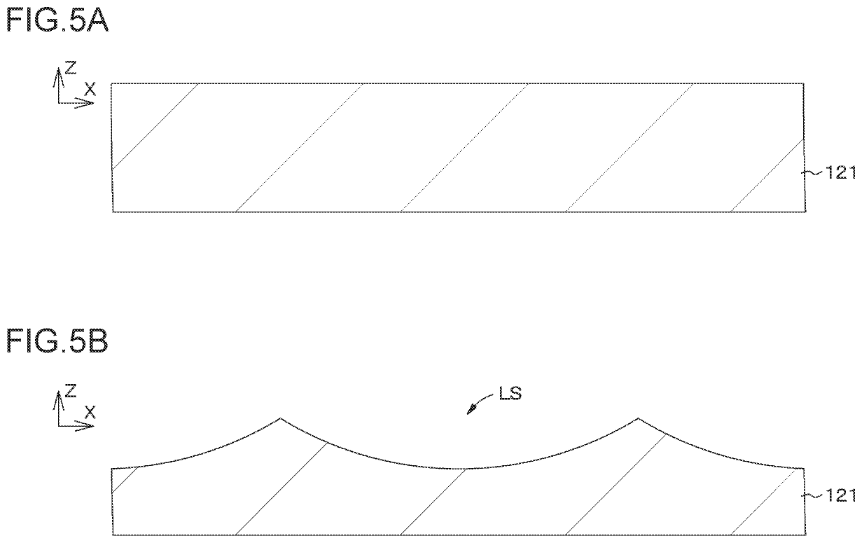

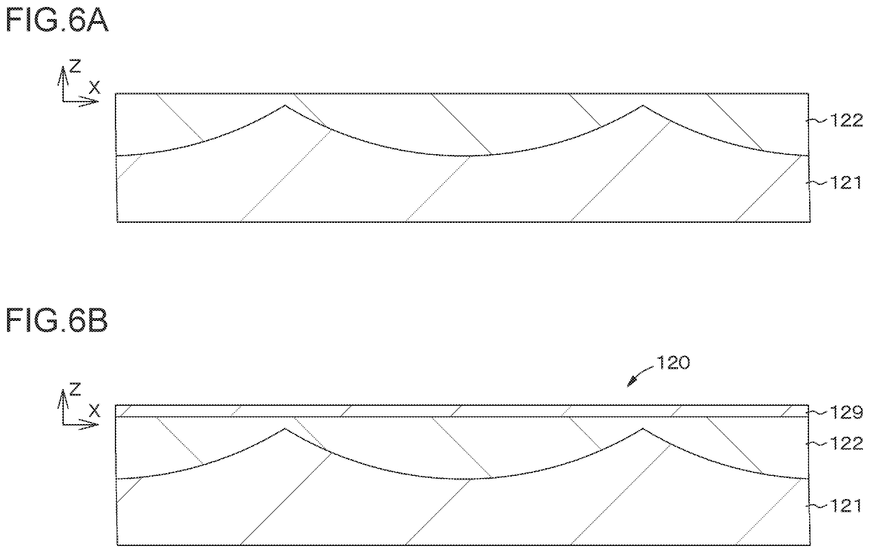

(See FIG. 5A, FIG. 5B, FIG. 6A, and FIG. 6B)

Subsequently, a step of forming the second substrate 120 including the optical element 122 is performed. First, the support 121 formed of quartz glass is prepared (see FIG. 5A), and a lens shape surface LS is formed thereon using a well-known lithography technology or the like (see FIG. 5B).

Next, a high-refractive index material layer forming a microlens is formed on the lens shape surface LS and then polished by CMP to from the optical element 122 (see FIG. 6A). The optical element 122 can be formed by using, for example, an inorganic material such as SiON or a resin-based high-refractive index material.

After that, the oxide film 129 for bonding is formed on the optical element 122. The oxide film 129 can be formed by a step similar to that of the above-mentioned oxide film 119 (see FIG. 6B).

[Step-120]

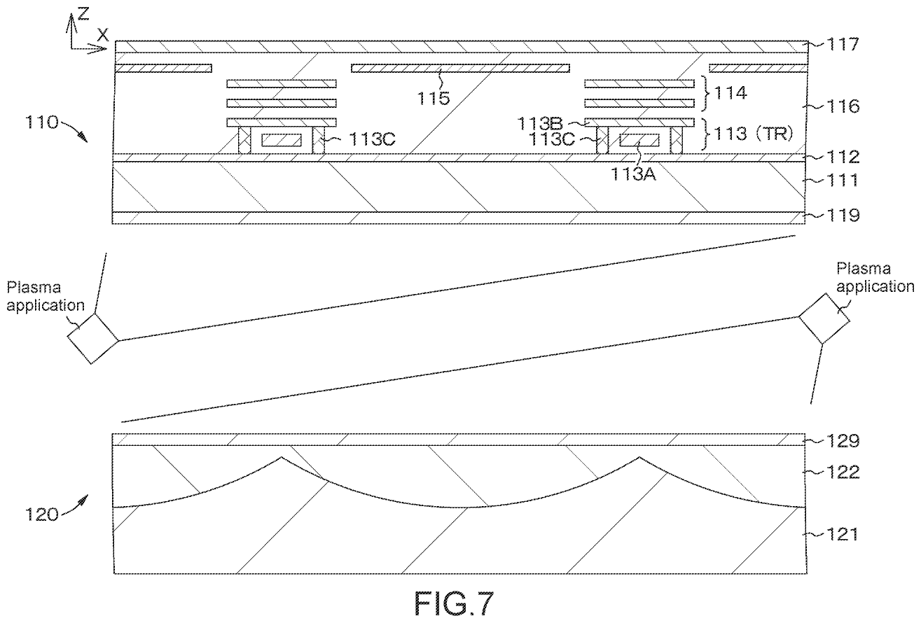

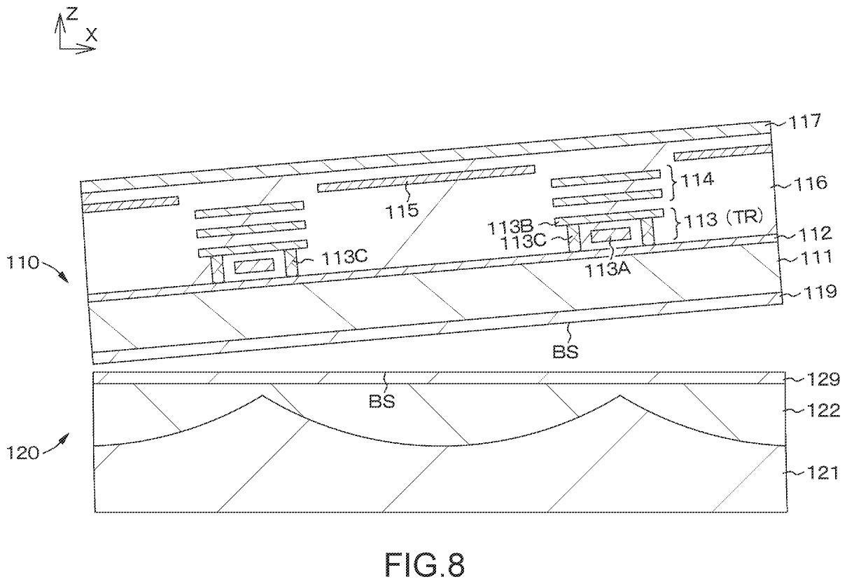

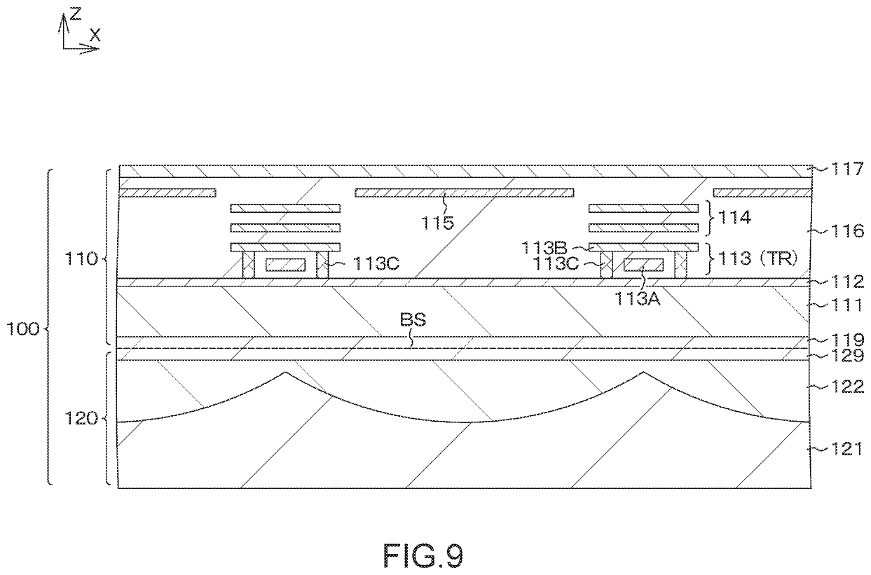

(See FIG. 7, FIG. 8, and FIG. 9)

Subsequently, a step of bonding, by plasma bonding treatment, the second substrate 120 to the back surface of the first substrate 110 that includes transistors arranged in an array is performed. First, in order to perform the plasma bonding of the first substrate 110 and the second substrate 120, activation treatment is performed on one or both of the bonding surfaces 119 and 129 (see FIG. 7). This is treatment for activating the OH groups on the bonding surface, and can generally be performed by plasma treatment, HF treatment, ozone treatment, or a combination thereof. The same applies to other embodiments described below.

Subsequently, while the positions of the first substrate 110 and the second substrate 120 are aligned (see FIG. 8), the bonding surface 119 and the bonding surface 129 are caused to face each other and bonded to each other (see FIG. 9). Since the bonding surfaces are activated, sufficient bonding strength can be achieved even if they are bonded to each other at room temperature, but it is possible to perform stronger bonding by further performing annealing treatment of approximately 400° C. Through the steps described above, the transistor array substrate 100 can be obtained. Further, by sealing the transistor array substrate 100 and the counter substrate 200 while sandwiching the liquid crystal material layer 300 between them, the liquid crystal display device 1 can be obtained.

Note that although it depends on the constituent material, the oxide films 119 and 129 can be omitted in the case where the support 111 and the optical element 122 can be directly plasma-bonded. Further, for example, in order to adjust the optical path length, the support 111 of the first substrate 110 may be appropriately thinned before bonding.

As described above, the heat treatment on the optical element 122 of the second substrate is limited to annealing treatment after bonding. The optical element 122 of the second substrate 120 is not exposed to heat treatment of approximately 1000° C. necessary for a transistor forming process. Therefore, it is possible to increase the degree of freedom of selection in the constituent material of the optical element 122 or the forming method therefor. For example, it is also possible to form a microlens using a nanoimprint technology.

In the case where the transistor array substrate 100 is produced without using the above-mentioned bonding step, it is necessary to perform a process of forming transistors after creating the microlens 122. In this case, a fine structure such as the microlens 122 is exposed to treatment of approximately 1000° C. in a transistor forming process a plurality of times. In high-temperature heat treatment, there is a high possibility that peeling, cracks, and the like occur in the microlens.

Further, in the case where the first substrate and the second substrate are bonded to each other using an adhesive, exposure to heat from the light source used in the liquid crystal display device may cause problems such as peeling, displacement, and yellowing of the adhesive surface due to the problem of light resistance.

Meanwhile, in the present disclosure, the first substrate and the second substrate are strongly bonded to each other by plasma bonding. Even if it is exposed to heat from the light source used in the liquid crystal display device, problems such as peeling and displacement do not occur. Further, the problem of light resistance does not occur.

Note that although the first substrate 110 and the second substrate 120 have been bonded to each other while the oriented film 117 has been formed in the first substrate 110 in [Step-100] n the above description, this is merely an example. For example, the oriented film 117 is not necessarily need to be formed in [Step-100] and the oriented film 117 may be formed after the first substrate 110 and the second substrate 120 are bonded to each other. The same applies also to the wiring layer 114, the pixel electrode 115, and the like.

Various modifications can be made for the above-mentioned transistor array substrate.

Hereinafter, various modified examples will be described.

### First Modified Example

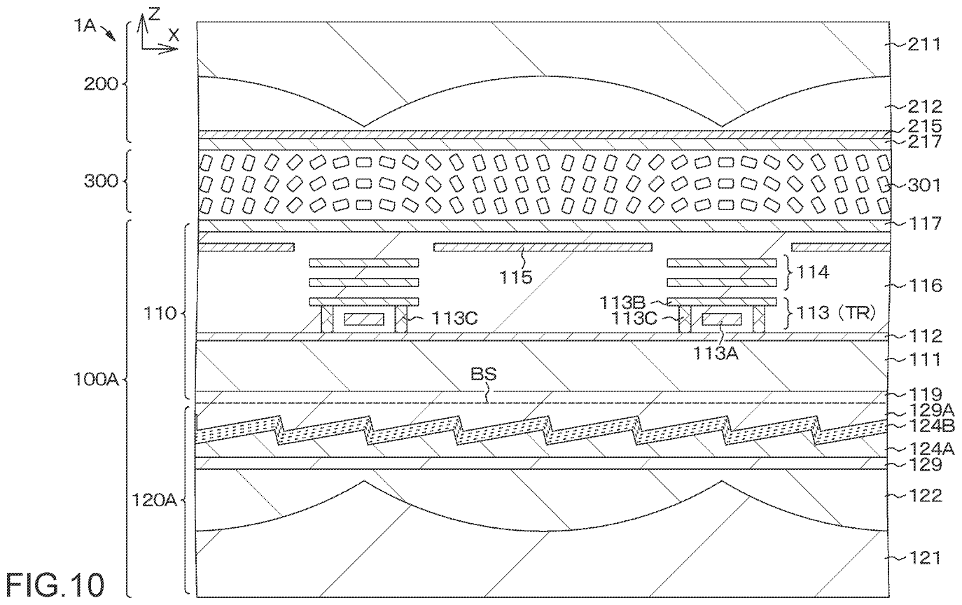

FIG. 10 is a schematic partial cross-sectional view describing a liquid crystal display device using a transistor array substrate according to a first modified example.

In the first embodiment, the microlens 122 has been formed as an optical element on the second substrate 120 of the liquid crystal display device 1. Meanwhile, in a liquid crystal display device 1A according to the first modified example, the main difference is that as the optical element of a second substrate 120A, both the microlens 122 and an optical compensation element 124B are formed. As will be described below, the optical compensation element 124B includes a laminated film having a blazed structure.

In a projector or the like using a liquid crystal display device, light that has passed through the liquid crystal display device to be elliptically polarized light is returned to linearly polarized light using an optical compensation element (optical compensation plate) in order to reduce light leakage and improve contrast. As this optical compensation element, a structure in which two glass substrates coated with a liquid crystal polymer are bonded to each other is well known, but an optical compensation element using an inorganic material has also been proposed due to a problem of a durability and the like. For example, an optical compensation element that functions as a C-plate having a configuration in which dielectric films having different refractive indices are laminated has been known.

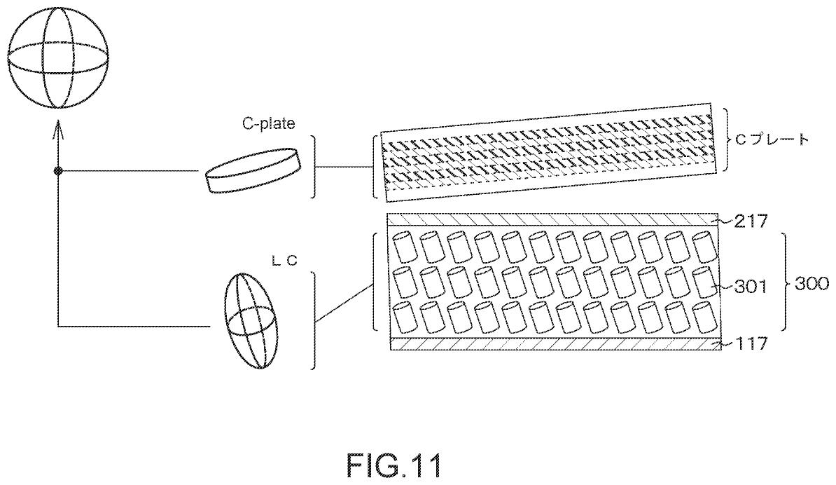

FIG. 11 is a schematic diagram describing the effect of optical compensation by tilting a C-plate.

In the case where the liquid crystal material layer 300 has a pretilt, it is necessary to diagonally dispose an optical compensation element that functions as a C-plate in accordance with the pretilt angle of the liquid crystal material layer 300 as shown in FIG. 11 in order to eliminate the light leakage using the optical compensation element that functions as a C-plate. However, diagonally disposing the optical compensation element causes an increase in the space of the optical system of the display device using a liquid crystal display device.

For this reason, an optical compensation element in which it is unnecessary to diagonally dispose the optical compensation element itself that function as a C-plate has been proposed. Hereinafter, description will be made with reference to the drawings.

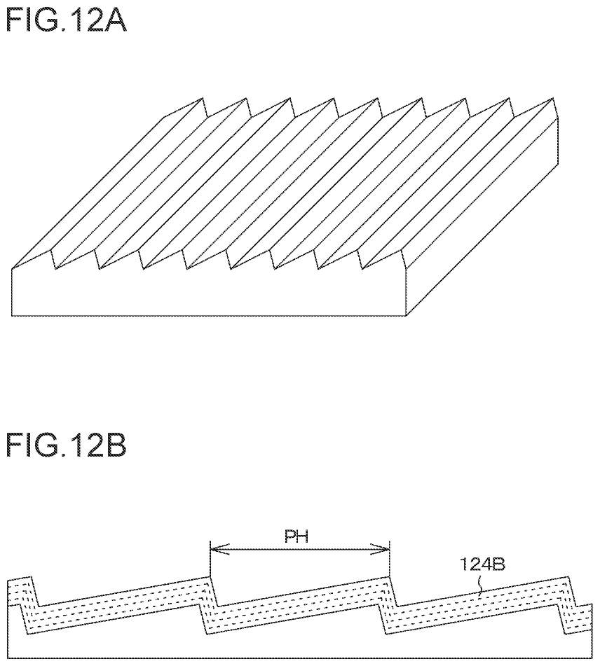

FIG. 12A is a schematic perspective view describing a blazed structure in which the cross section of the lattice groove is serrated. FIG. 12B is a schematic partial cross-sectional view describing an optical element including an optical compensation film formed on the blazed structure.

In the transistor array substrate according to the first modified example, the optical compensation element 124B having a configuration in which dielectric films having different refractive indices are laminated on a blazed structure shown in FIG. 12A is used (see FIG. 12B). The optical compensation element 124B is incorporated in the liquid crystal display device 1A in an in-cell state, and functions as a C-plate that is optically diagonally disposed. A pitch PH of the blazed structure shown in FIG. 12B is favorably equal to or lower than the wavelength of light used for display. For example, the pitch PH is set to a value such as 200 nanometers.

Subsequently, the method of producing a transistor array substrate 100A will be described.

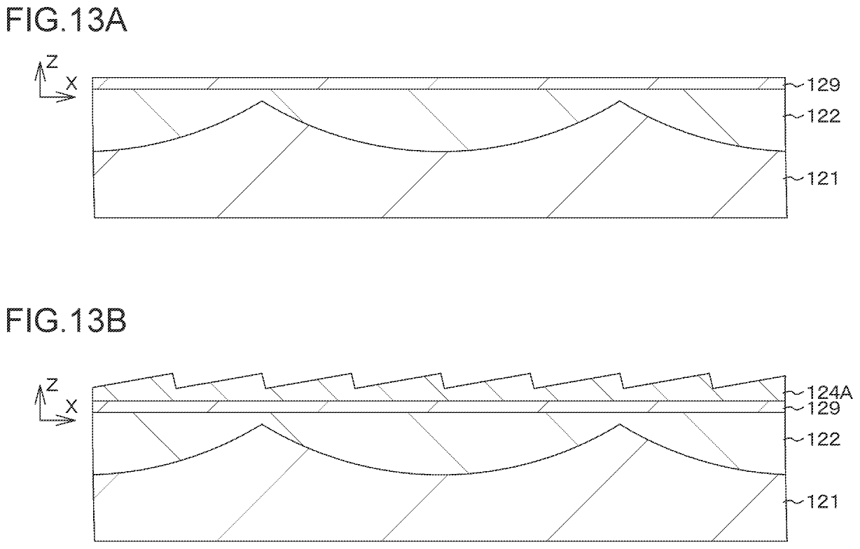

FIG. 13 to FIG. 15 are each a schematic partial plan view describing the method of producing a transistor array substrate. Hereinafter, the method of producing the transistor array substrate 100A will be described in detail with reference to these figures.

[Step-100A]

A step similar to the step described in the above-mentioned [Step-100] is performed to prepare the first substrate 110 in which transistors arranged in an array, and the like are formed (see the above-mentioned FIG. 4B).

[Step-110A]

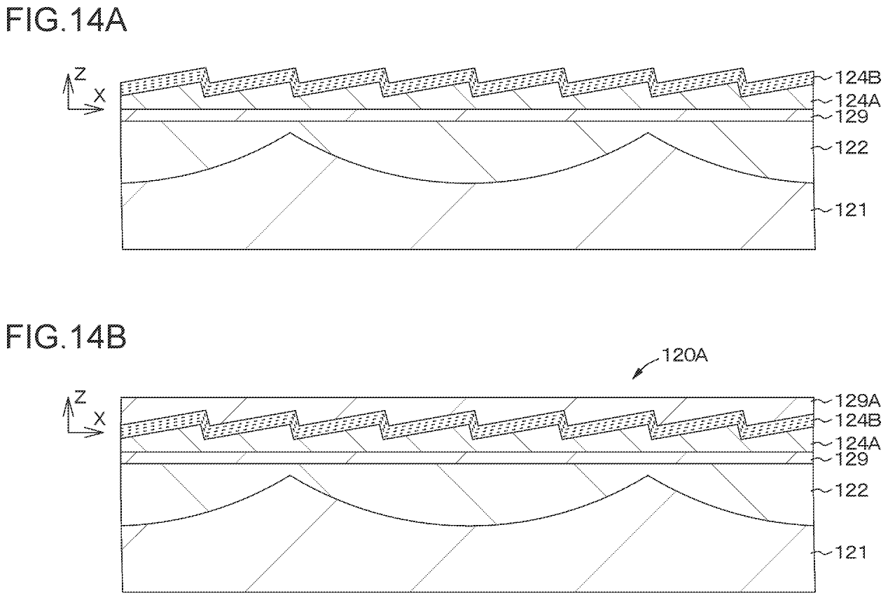

(See FIG. 13A, FIG. 13B, FIG. 14A, and FIG. 14B) Subsequently, a step of forming a second substrate 120A including the microlens 122 and an optical element 124B is performed.

First, a step similar to the step described in the above-mentioned [Step-110] is performed to form the microlens 122 and the oxide film 129 on the support 121 (see FIG. 13A).

Subsequently, after depositing SiO₂ using a CVD method on the oxide film 129 to have a thickness of 200 nanometers, a resist was patterned into a blazed structure by a method such as nanoimprint and then, a blazed structure 124A was formed using an etch back method. The blazed structure has a pitch of 200 nanometers and a height of 100 nanometers (see FIG. 13B).

Subsequently, a high-refractive index material film and a low-refractive index material film are repeatedly laminated on the blazed structure 124A to form the optical compensation element 124B (see FIG. 14A). For example, a TiO₂ film (thickness of 30 nanometers) and an SiO₂ film (thickness of 30 nanometers). are alternately laminated to have 30 layers respectively as a high-refractive index material film and a low-refractive index material film. Note that since the blazed structure is flattened by a sputtering method, a CVD method, or the like, deposition was performed using an oblique vapor deposition method such that anisotropic deposition is performed in the vertical direction on the slope of the blazed structure.

After that, an oxide film 129A is deposited on the optical compensation element 124B (see FIG. 14B). The oxide film 129A is used for bonding to the first substrate 110. The oxide film 129A can be formed by a step similar to that of the above-mentioned oxide film 119.

[Step-120A]

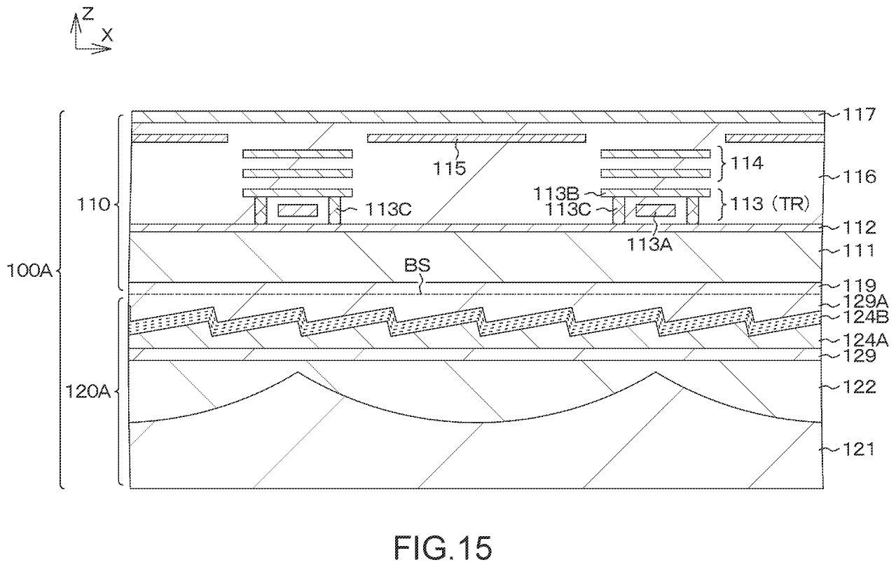

(See FIG. 15)

Subsequently, a step of bonding, by plasma bonding treatment, the second substrate 120A to the back surface of the first substrate 110 that includes transistors arranged in an array is performed. Activation treatment is performed on one or both of the bonding surfaces 119 and 129A, and the bonding surface 119 and the bonding surface 129 are caused to face each other and bonded to each other (see FIG. 15) while the positions of the first substrate 110 and the second substrate 120A are aligned. Through the steps described above, the transistor array substrate 100A including the optical compensation element 124B and the microlens 122 provided as in-cell elements below the transistors can be obtained. Further, by sealing the transistor array substrate 100A and the counter substrate 200 while sandwiching the liquid crystal material layer 300 between them, the liquid crystal display device 1A can be obtained.

As described above, heat treatment on the optical elements 122 and 124B of the second substrate 120A is limited to annealing treatment after bonding. The optical elements 122 and 124B of the second substrate 120A are not exposed to heat treatment of approximately 1000° C. necessary for a transistor forming process. Therefore, it is possible to increase the degree of freedom in selection of the constituent material of the optical elements 122 and 124B or the forming method therefor.

### Second Modified Example

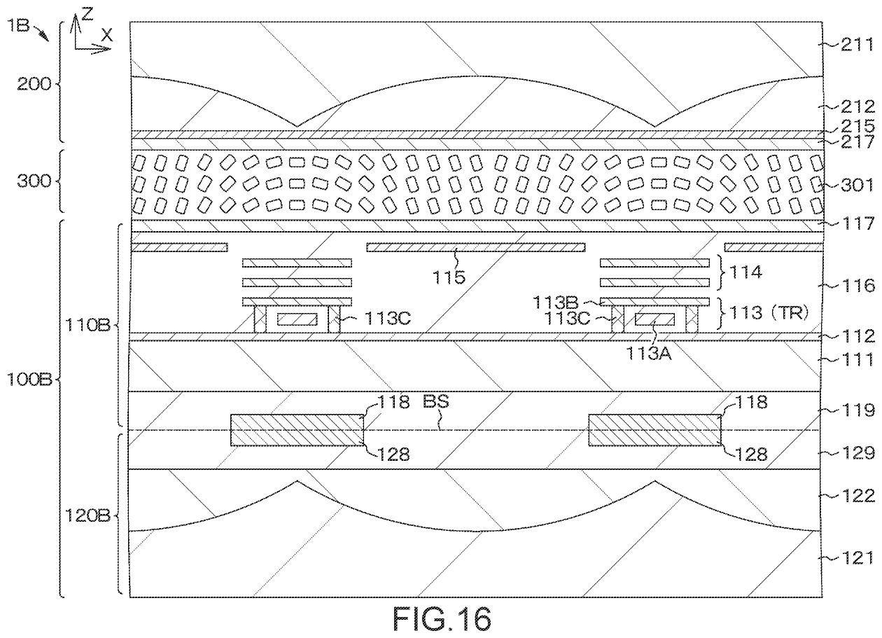

FIG. 16 is a schematic partial cross-sectional view describing a liquid crystal display device using a transistor array substrate according to a second modified example.

In the transistor array substrate 100 used in the liquid crystal display device 1 according to the first embodiment, the oxide film 119 on the side of the first substrate 110 and the oxide film 129 on the side of the second substrate 120 have been bonded to each other by plasma bonding treatment. Meanwhile, in a transistor array substrate 100B used in a liquid crystal display device 1B according to the second modified example, the main difference is that a metal wiring 118 on the side of a first substrate 110B and a metal wiring 128 on the side of a second substrate 120B are bonded to each other by plasma bonding treatment. The metal wirings 118 and 128 are formed in a grid pattern so as to surround a pixel unit, for example.

For convenience of illustration, the thickness of the metal wiring is shown to be smaller than the width in the figure. Actually, the width of the metal wiring is approximately 0.7 micrometer and the thickness is approximately 1 micrometer. Further, although only a microlens is formed as an optical element on the second substrate 120B in the following description, a microlens and an optical compensation element may be formed as optical elements, similarly to the second modified example.

[Step-100B]

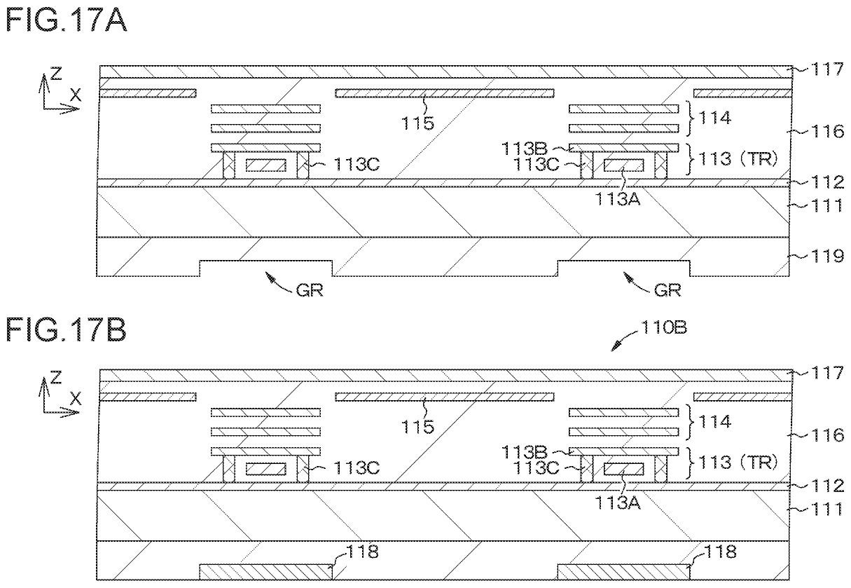

(See FIG. 17A and FIG. 17B)

A step similar to the step described in the above-mentioned [Step-100] is performed to prepare the first substrate 110B in which transistors arranged in an array, and the like are formed. Subsequently, a wiring groove GR is formed in the oxide film 119 (see FIG. 17A).

Subsequently, tantalum is deposited as a barrier metal on the entire surface including the wiring groove GR to have a thickness of approximately 30 nanometers, and then, a seed layer using copper is formed to have a thickness of approximately 100 nanometers. After that, copper is deposited by electrolytic plating method and then polished by CMP to form the metal wiring 118 using copper (see FIG. 17A).

[Step-110B]

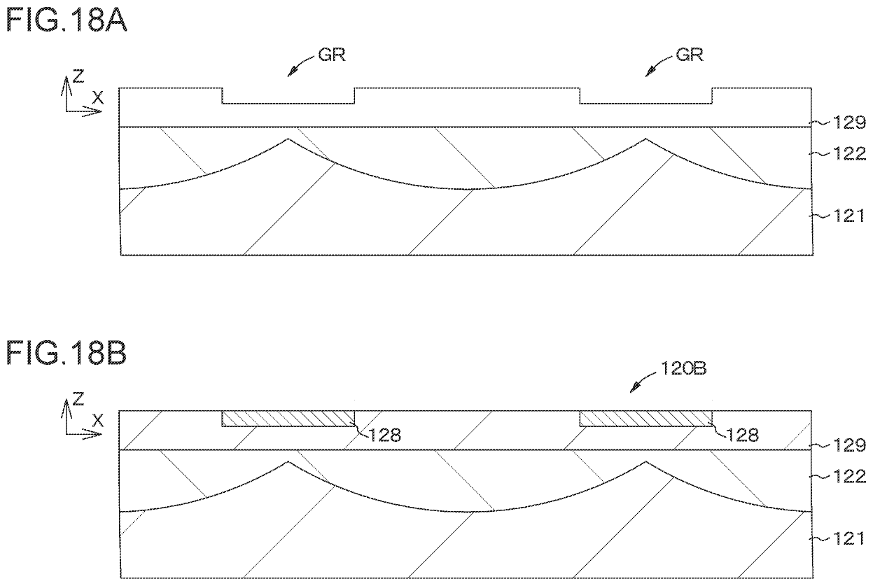

(See FIG. 18A and FIG. 18B)

A step similar to the step described in the above-mentioned [Step-110] is performed to prepare the second substrate 120B in which the optical element 122 has been formed. Subsequently, the wiring groove GR is formed in the oxide film 129 (see FIG. 18A). Subsequently, the metal wiring 128 using copper is formed by a step similar to the step described for the first substrate 110B (see FIG. 18B).

[Step-120B]

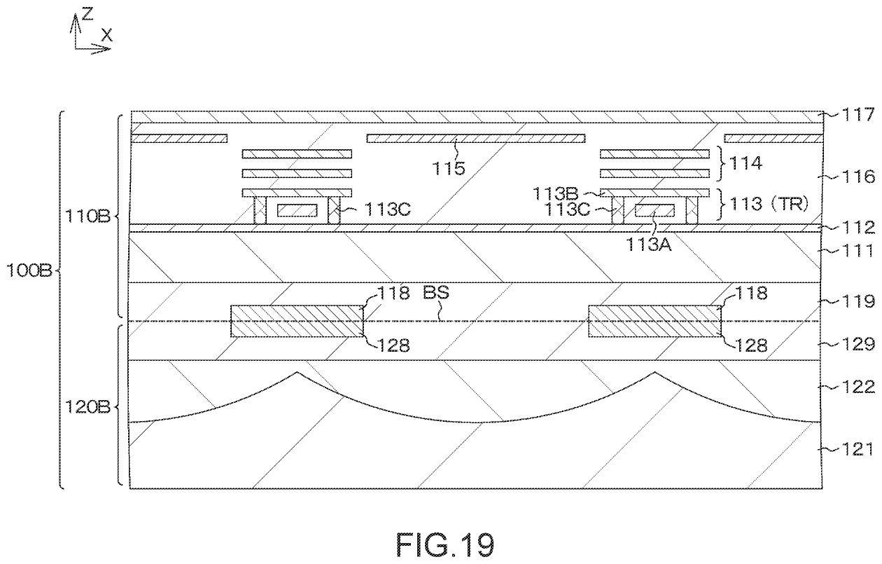

(See FIG. 19)

Subsequently, a step of bonding, by plasma bonding treatment, the second substrate 120B to the back surface of the first substrate 110B that includes transistors arranged in an array is performed (see FIG. 19). Through the steps described above, the transistor array substrate 100B including the microlens 122 provided as an in-cell element below the transistors can be obtained. Further, by sealing the transistor array substrate 100B and the counter substrate 200 while sandwiching the liquid crystal material layer 300 between them, the liquid crystal display device 1B can be obtained.

In the case where the transistor array substrate 100B is produced without using the above-mentioned bonding step, it is necessary to form a metal wiring using copper before the transistor forming process. At the time of treatment of approximately 1000° C. in the transistor forming process, the barrier property of the barrier metal is insufficient and copper atoms diffuse, resulting in malfunction of the transistors. Therefore, it is difficult to realize this configuration without using bonding.

Note that with the increase in luminance of a display device using a liquid crystal display device, improvement of the heat dissipation property of the liquid crystal display device is also desired. Quartz glass has thermal conductivity of approximately 1.4 [W/mK], but copper has high thermal conductivity, i.e., approximately 386 [W/mK], and easily transfers heat. In the second modified example, since a metal wiring using copper is disposed in the pixel unit in a grid pattern, the heat of the liquid crystal display device can be transferred to the end portion. By thermally connecting the metal wiring at the end portion to the outer frame or the like with a bump structure or the like, it is possible to cause the metal wiring to operate as the heat dissipation mechanism of the liquid crystal display device.

Further, another substrate may be further bonded to at least one of a side of the first substrate and a side of the second substrate by plasma bonding treatment. For example, a substrate on which a driver circuit or the like is mounted can be incorporated on the side of the second substrate 120B. In this case, the metal wiring using bonding can be appropriately patterned to be used for electrical connection between the side of the first substrate and the side of the second substrate.

### Third Modified Example

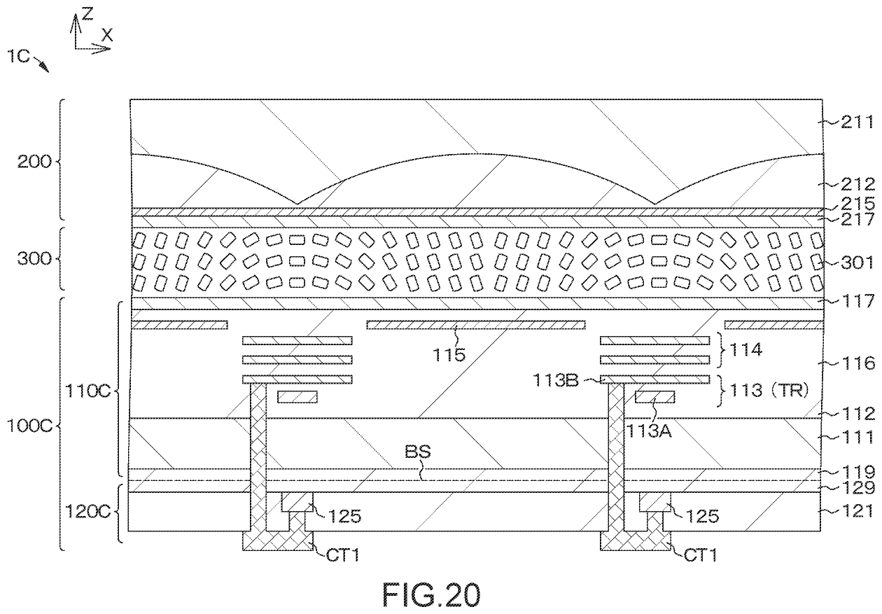

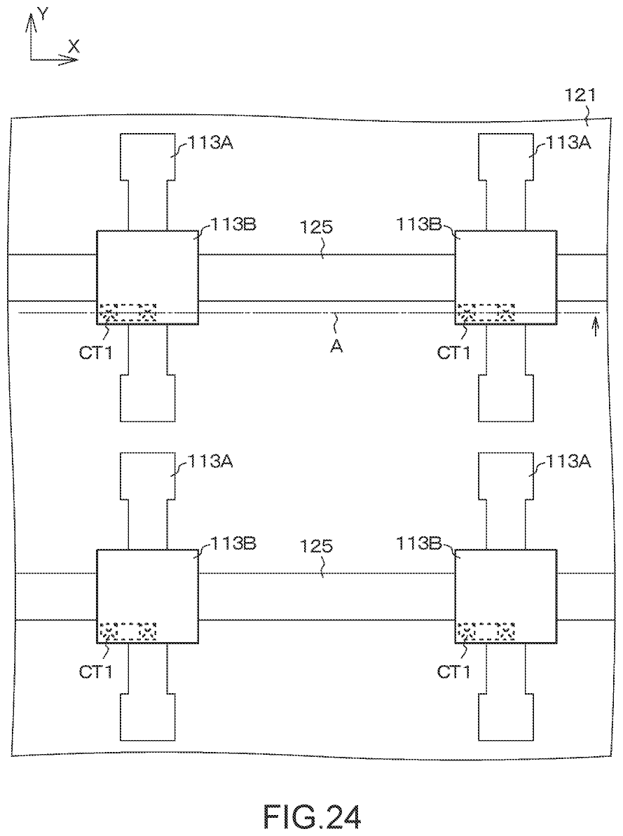

FIG. 20 is a schematic partial cross-sectional view describing a liquid crystal display device using a transistor array substrate according to a third modified example. As will be described below in detail, it corresponds to the cross-sectional view of the portion of the reference symbol A indicated by a dot-dash line in FIG. 24 described below. Since the dot-dash line in FIG. 24 intersects the branch wiring of a shading part 125, only the cross section of the branch wiring is shown in FIG. 20.

In the first embodiment, the microlens 122 has been formed as an optical element on the second substrate 120 of the liquid crystal display device 1. Meanwhile, in a liquid crystal display device 1C according to the third modified example, the shading part 125 that is disposed so as to be located on the back surface of the transistors is formed as an optical element of a second substrate 120C.

Further, the above-mentioned shading part 125 is formed so as to function as a scan line of the liquid crystal display device 1C, for example. For this reason, a scan line is omitted from a second substrate 110C, and a contact CT1 that connects the shading part 125 of the second substrate 120C and a gate electrode of a transistor of the first substrate 110C to each other is provided. The contact CT1 is formed using a via hole provided from a side of a surface opposite to a bonding surface BS in the second substrate 120C.

The shading part 125 is not exposed to treatment of approximately 1000° C. in the transistor forming process. Therefore, as the material forming the shading part 125, a metal material that has a low melting point, a high light-shielding property, and excellent conductivity, such as aluminum (Al), can be used. Further, even in the case where a metal having a high melting point, such as tungsten (W) and tungsten silicide (WSi), is used, it is possible to prevent the film quality from deteriorating due to exposure to high temperature.

Further, since the light-shielding performance on the side of the back surface is also improved, the light incident direction can be the lower side of the substrate, which is opposite to the existing direction, and the degree of freedom in designing the optical system is improved. Further, it is also possible to improve the aperture ratio by narrowing the wiring width necessary for light blocking.

First, the lamination relationship of the transistor array substrate will be described with reference to FIG. 21 to FIG. 24. More specifically, the planar disposition relationship between the shading part 125 and the transistors 113 will be described.

As shown in FIG. 21, the shading part 125 formed in the support 121 of the second substrate 120C includes a trunk wiring formed so as to extend in the X direction and a branch wiring extending in the Y direction. In FIG. 21, a hatched portion shows the planar shape of the shading part 125.

The semiconductor material layer 113A constituting the transistor 113 formed on the first substrate 110C is formed in an island shape and is disposed so as to cover the branch wiring of the shading part 125. In FIG. 22, a hatched portion shows the planar shape of the semiconductor material layer 113A.

Also the gate electrode 113B constituting the transistor 113 is formed in an island shape and is disposed so as to cover the portion in which the semiconductor material layer 113A and the trunk wiring of the shading part 125 overlap with each other. In FIG. 23, a hatched portion shows the planar shape of the gate electrode 113B.

The gate electrode 113B and the light-shielding layer 125 are connected to each other by the contact CT1 formed using a via hole provided from a side of a surface opposite to the bonding surface BS in the second substrate 120C. In FIG. 24, a portion where the contact CT1 is disposed is shown by a fine broken line.

In FIG. 24, the portion of the semiconductor material layer 113A overlapping with the gate electrode 113B is the channel forming region, and both ends of the semiconductor material layer 113A are one pair of source/drain regions. The data line included in the wiring 114 in FIG. 20 is connected to one source/drain region and the pixel electrode 115 is connected to the other source/drain region.

The lamination relationship of the transistor array substrate has been described above. Subsequently, a method of producing a transistor array substrate 100C will be described.

[Step-100C]

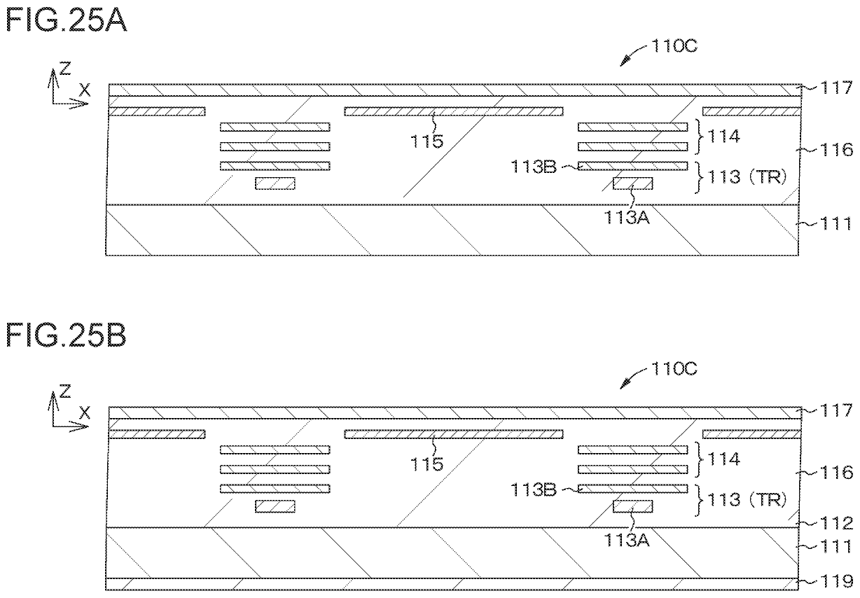

(See FIG. 25A and FIG. 25B)

A step obtained by omitting the formation of the scan line 112 from the step described in the above-mentioned [Step-100] is performed. After obtaining the first substrate 110C (see FIG. 25A) in which transistors arranged in an array, and the like have been formed, the oxide film 119 for bonding is formed on the back surface of the support 111 (see FIG. 25B).

[Step-110C]

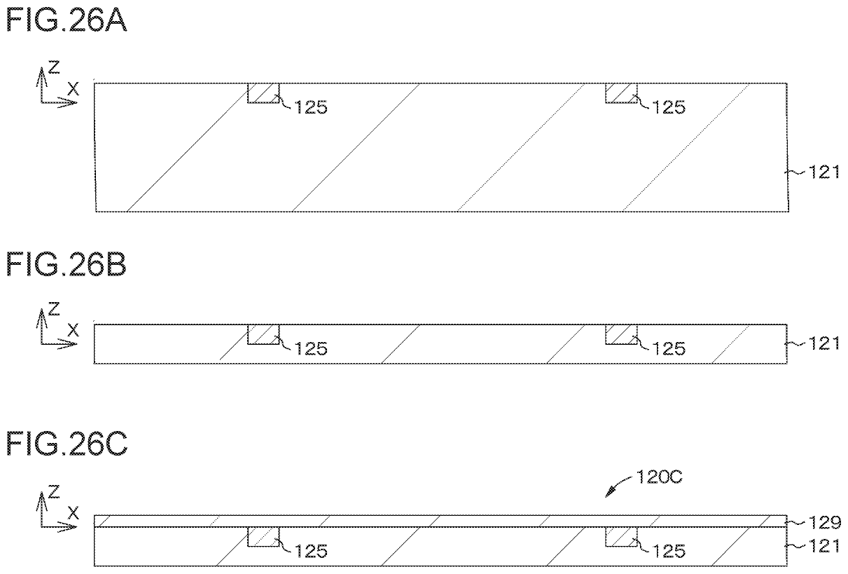

(See FIG. 26A, FIG. 26B, and FIG. 26C)

Subsequently, a step of forming the second substrate 120C is performed. The support 121 formed of quartz glass is prepared, and then, the shading part 125 embedded in the support 121 is formed. The shading part 125 can be formed by performing a step similar to the step described in [Step-110B] except that an aluminum-based alloy (e.g., AlSi) is used instead of copper (see FIG. 26A). After that, if necessary, the support 121 is thinned (see FIG. 26B). Subsequently, the oxide film 129 for bonding is formed on the entire surface including the shading part 125 (see FIG. 26C).

[Step-120C]

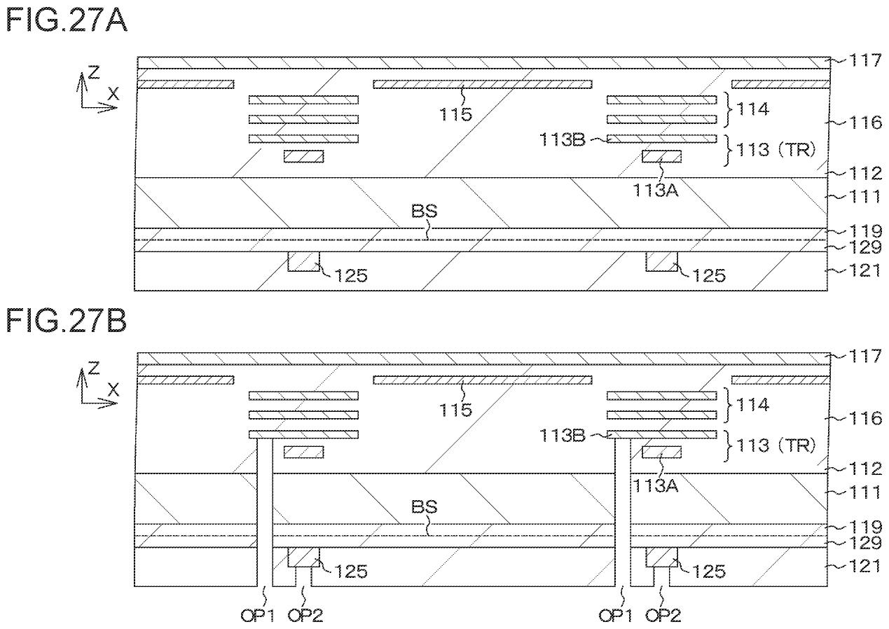

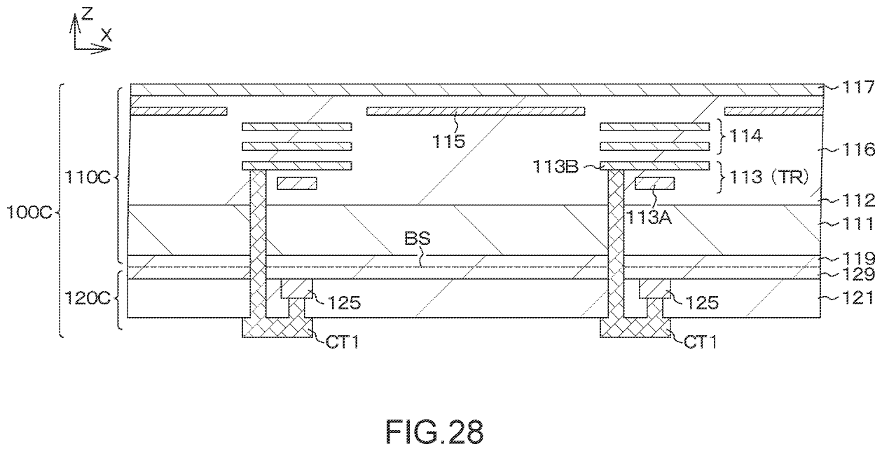

(See FIG. 27A, FIG. 27B, and FIG. 28)

Subsequently, a step of bonding, by plasma bonding treatment, the second substrate 120C to the back surface of the first substrate 110C that includes transistors arranged in an array is performed (see FIG. 27).

Subsequently, the contact CT1 that connects the shading part 125 of the second substrate 120C and the gate electrode 113B of the transistor of the first substrate 110C to each other is formed. First, via holes OP1 and OP2 provided from a side of a surface opposite to the bonding surface BS in the second substrate 120C are formed (see FIG. 27B). The via hole OP1 is formed such that the gate electrode 113B is exposed. Further, the via hole OP2 is formed such that the shading part 125 is exposed.

After that, by embedding a conductive material so as to fill the via holes OP1 and OP2 and connect them to each other, the contact CT1 is formed (see FIG. 28).

Through the steps described above, the transistor array substrate 100C including the shading part 125 provided as an in-cell element below the transistors can be obtained. Further, by sealing the transistor array substrate 100B and the counter substrate 200 while sandwiching the liquid crystal material layer 300 between them, the liquid crystal display device 1C can be obtained.

### Fourth Modified Example

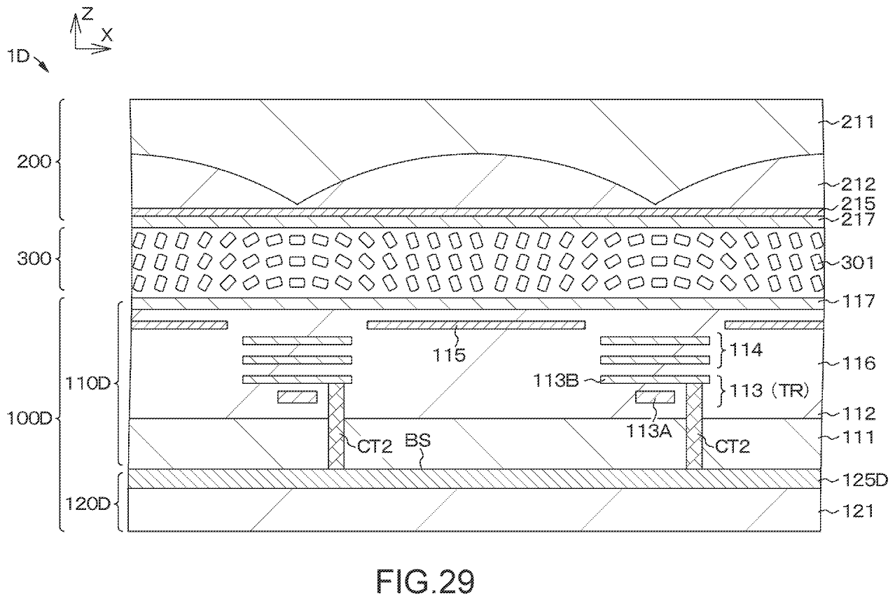

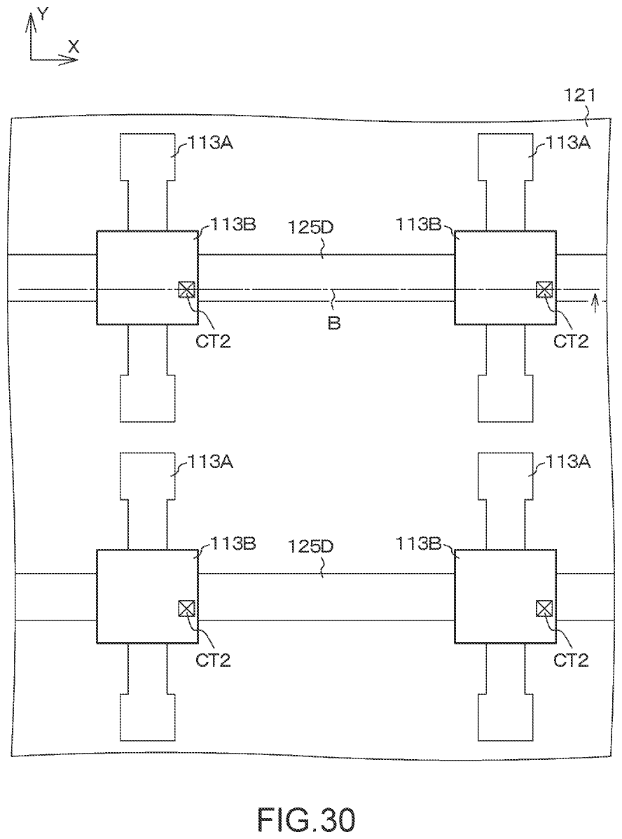

FIG. 29 is a schematic partial cross-sectional view describing a liquid crystal display device using a transistor array substrate according to a fourth modified example. FIG. 30 is a schematic partial plan view describing the lamination relationship of the transistor array substrate. FIG. 29 corresponds to a cross-sectional view of a portion of the reference symbol B indicated by a dot-dash line in FIG. 30. Note that since the dot-dash line in FIG. 30 is located on the trunk wiring of a shading part 125D, the cross section of the trunk wiring is shown in FIG. 29.

In the third modified example, a shading part has been formed using an aluminum-based alloy and a contact has been formed using a via hole provided from a side of a surface opposite to the bonding surface BS in a second substrate. Meanwhile, in the fourth modified example, the main difference is that the shading part 125D is formed using copper and a contact CT2 is formed using a via hole provided from the side of the bonding surface BS in a first substrate 110D.

The contact CT2 is disposed so as to be connected to the gate electrode 113B and is formed using copper. When the first substrate 110D and a second substrate 120D are plasma-bonded, a Cu—Cu bond is formed between the shading part 125D and the contact CT2 to achieve conduction.

The lamination relationship of the transistor array substrate has been described. Subsequently, a method of producing the transistor array substrate 100C will be described.

[Step-100D]

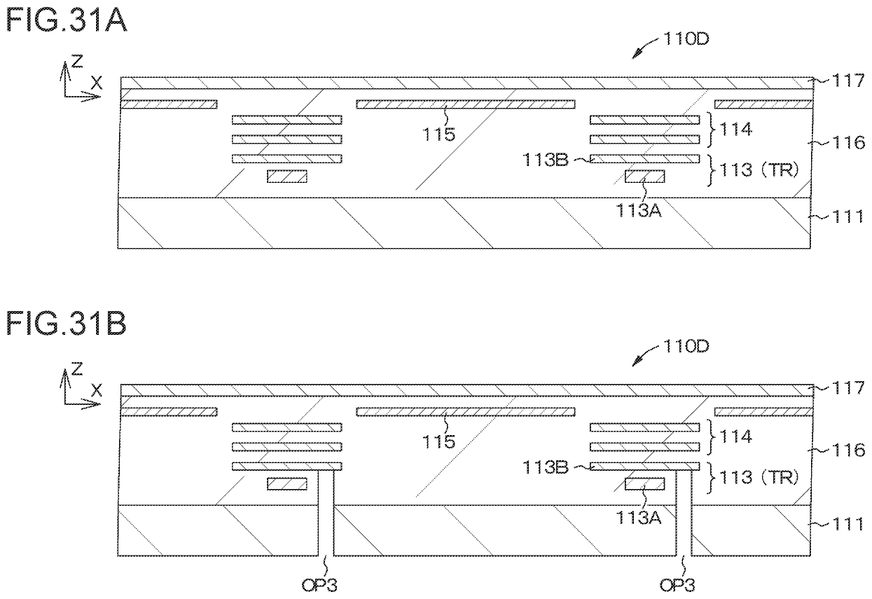

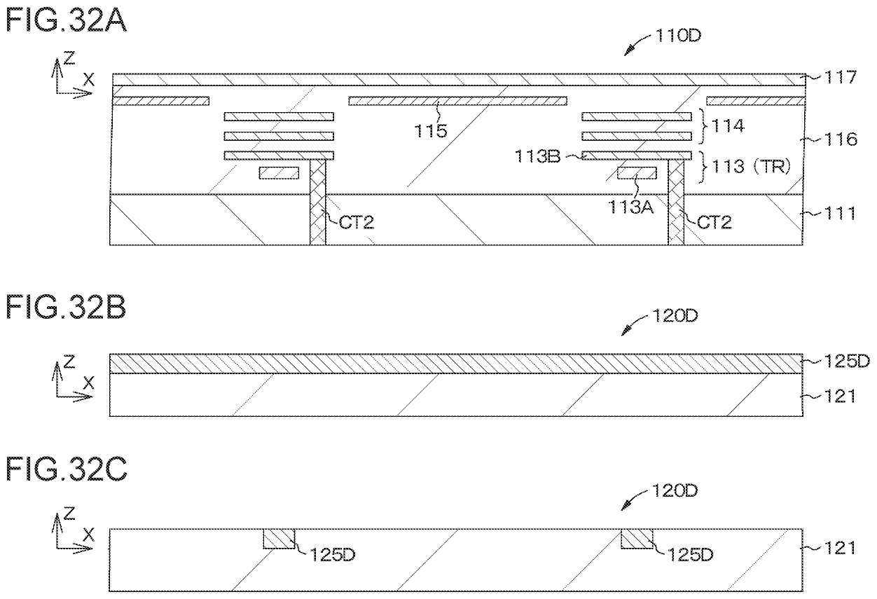

(See FIG. 31A, FIG. 31B, and FIG. 32A)

A step obtained by omitting the formation of the scan line 112 from the step described in the above-mentioned [Step-100] is performed. The first substrate 110D in which transistors arranged in an array, and the like are formed is obtained (see FIG. 31A). Note that the oxide film 119 for bonding may be formed on the back surface of the support 111 or may be omitted. The figure shows an example in which the oxide film 119 is omitted.

Subsequently, the contact CT2 that is to be connected to the gate electrode 113B is formed. First, a via hole OP3 provided from the side of the bonding surface BS in the first substrate 110D is formed (see FIG. 31B). The via hole OP3 is formed such that the gate electrode 113B is exposed.

Subsequently, copper is deposited on the entire surface including the via hole OP3 and then polished by CMP. As a result, it is possible to form the contact CT2 embedded in the support 111 or the like (see FIG. 32).

[Step-110D]

(See FIG. 32B and FIG. 32C)

Subsequently, a step of forming the second substrate 120D is performed. The support 121 formed of quartz glass is prepared, and then, the shading part 125D embedded in the support 121 is formed. The shading part 125D can be formed by performing a step similar to the step described in [Step-110B] (see FIG. 32B). Note that for reference, the cross section of a portion of the shading part 125D including a branch wiring is shown in FIG. 32C.

[Step-120C]

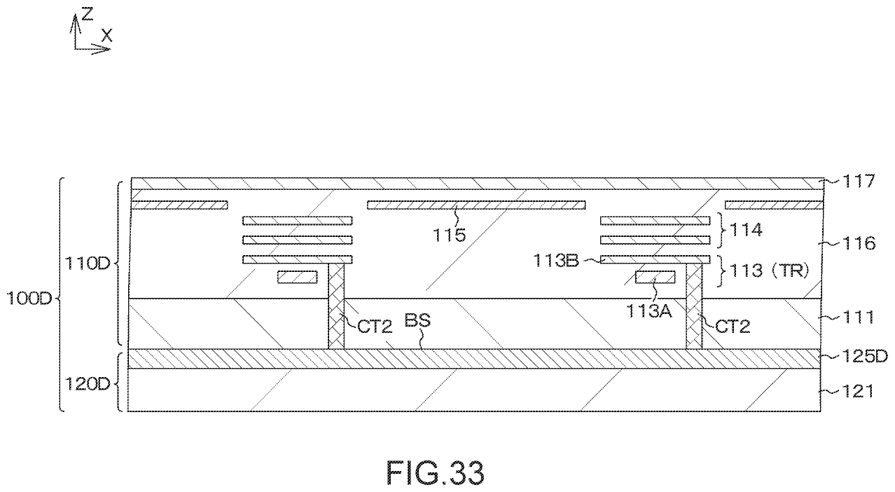

(See FIG. 33)

Subsequently, a step of bonding, by plasma bonding treatment, the second substrate 120D to the back surface of the first substrate 110D that includes transistors arranged in an array is performed (see FIG. 33). Through the steps described above, the transistor array substrate 100D including the shading part 125D as an in-cell element below the transistors can be obtained. Further, by sealing the transistor array substrate 100D and the counter substrate 200 while sandwiching the liquid crystal material layer 300 between them, a liquid crystal display device 1D can be obtained.

### Fifth Modified Example

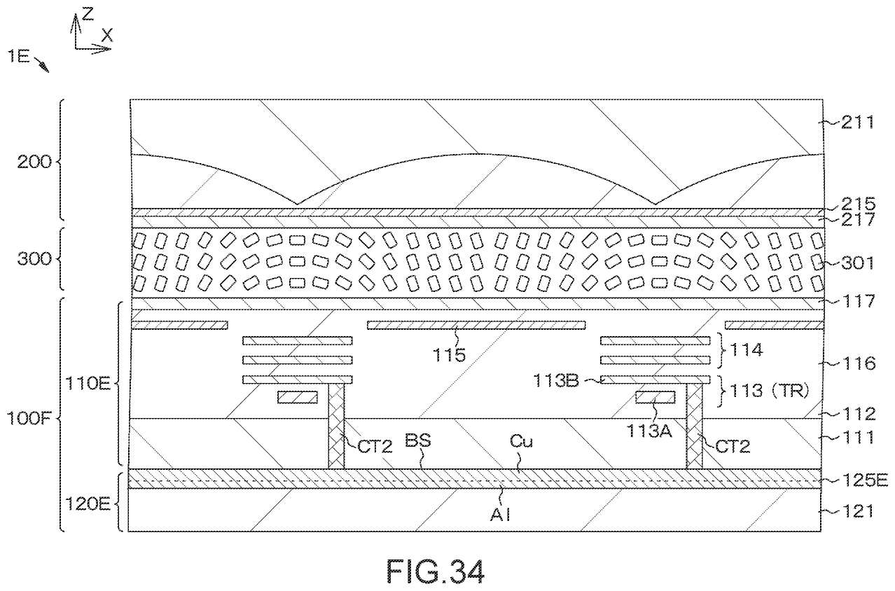

FIG. 34 is a schematic partial cross-sectional view describing a liquid crystal display device using a transistor array substrate according to a fifth modified example.

In the fourth modified example, the shading part 125D has been formed using copper. Meanwhile, a liquid crystal display device 1E according to the fifth modified example, the main difference is that a shading part 125E includes a wiring in which copper and a metal different from copper are laminated.

Copper has the advantage of low resistivity, but the light-shielding performance thereof is not necessarily high as compared with those of other metals. In this regard, the shading part 125E can include a wiring in which copper and a metal different from copper are laminated to improve the light-shielding property. In the example shown in the figure, the shading part 125D is formed by a wiring in which an upper layer of copper and a lower layer of aluminum are laminated. Also in this configuration, the contact CT2 and the shading part 125E are capable of achieving a Cu—Cu bond, similarly to the fourth modified example.

Description of the method of producing the liquid crystal display device 1E is omitted because it only needs to deposit aluminum first, then deposit copper, and apply CMP thereto to form the shading part 125E embedded in a wiring groove in the above-mentioned

[Step-110D].

Note that the configuration of the shading part 125E is not limited thereto, and a form of including a wiring in which copper and tungsten are laminated may be adopted.

[Description of Electronic Apparatus]

The liquid crystal display device according to the present disclosure described above can be used as a display unit (display device) of an electronic apparatus in all fields in which a video signal input to the electronic apparatus or a video signal generated in the electronic apparatus is displayed as an image or video. As an example, it can be used as a display unit of a television set, a digital still camera, a notebook personal computer, a portable terminal device such as a mobile phone, a video camera, a head-mounted display, or the like.

The liquid crystal display device according to the present disclosure includes also one having a module shape with a sealed configuration. Note that a circuit unit or a flexible printed circuit (FPC) for inputting/outputting signals or the like from the outside to a pixel array unit may be provided in the display module. Hereinafter, as a specific example of an electronic apparatus using the liquid crystal display device according to the present disclosure, a projection type display device is illustrated. However, the specific example exemplified here is merely an example, and the present disclosure is not limited thereto.

### Specific Example 1

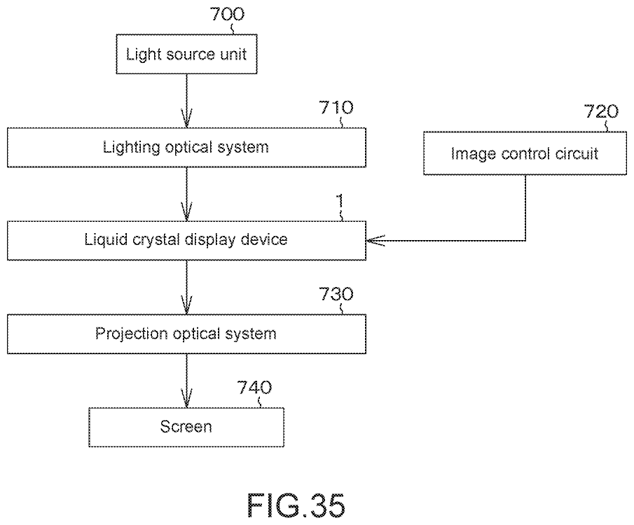

FIG. 35 is a conceptual diagram of a projection type display device using the liquid crystal display device according to the present disclosure. The projection type display device includes a light source unit 700, a lighting optical system 710, the liquid crystal display device 1, an image control circuit 720 that drives the liquid crystal display device, a projection optical system 730, a screen 740, and the like. The light source unit 700 can include, for example, various lamps such as a xenon lamp or a semiconductor light-emitting element such as a light-emitting diode. The lighting optical system 710 is used for guiding light from the light source unit 700 to the liquid crystal display device 1, and includes an optical element such as a prism and a dichroic mirror. The liquid crystal display device 1 operates as a light valve, and an image is projected on the screen 740 via the projection optical system 730.

For example, in the liquid crystal display devices according to the fourth modified example to the sixth modified example, the shading part disposed on the side of the back surface of the transistors is not exposed to high temperature of a transistor forming process. Therefore, it is possible to achieve light blocking by the shading part even when light is incident from the side of the back surface. Since the light source unit 700 can be disposed on any of the upper surface side and the back surface side of the liquid crystal display device, it is possible to increase the degree of freedom in layout of the display device.

### Application Example

The technology according to the present disclosure is applicable to various products. For example, the technology according to the present disclosure may be realized as an apparatus installed in any kind of moving object such as automobiles, electric cars, hybrid electric vehicles, motorcycles, bicycles, personal mobility, airplanes, drones, ships, robots, construction equipment, and agricultural machinery (tractors).

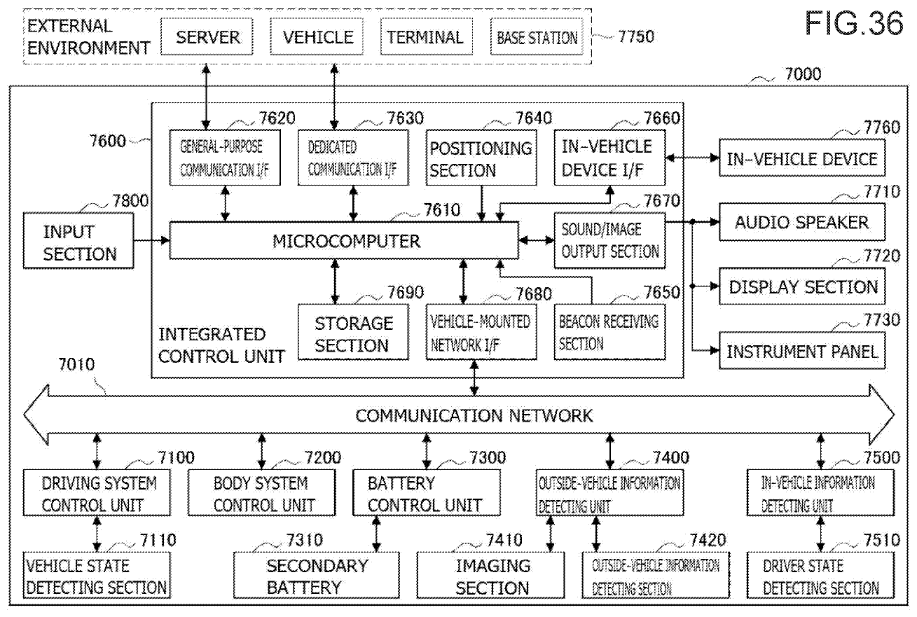

FIG. 36 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 36, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 36 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

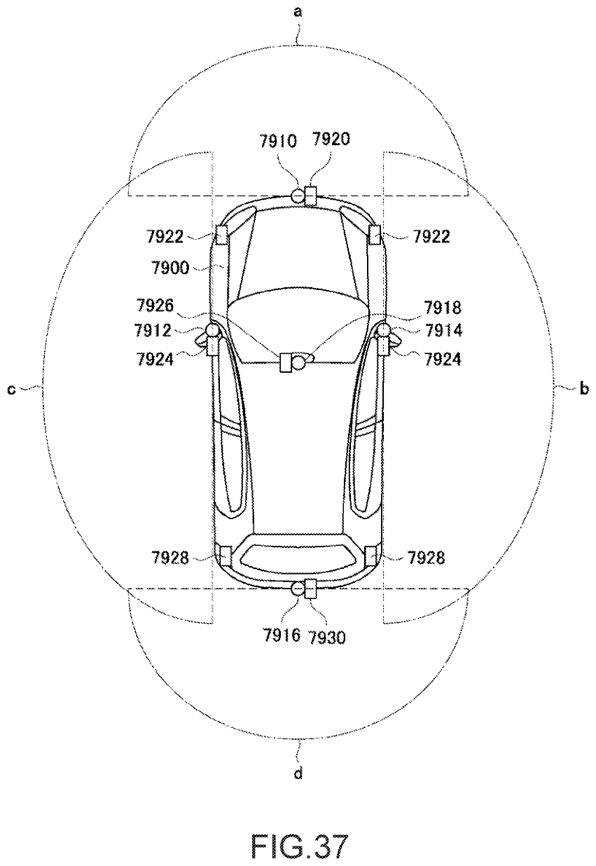

FIG. 37 depicts an example of installation positions of the imaging section 7410 and the outside-vehicle information detecting section 7420. Imaging sections 7910, 7912, 7914, 7916, and 7918 are, for example, disposed at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 37 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 36, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LIE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 36, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 36 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

The technology according to the present disclosure is applicable to, for example, a display unit of an output apparatus capable of visually or audibly notifying information, of the configurations described above.

[Others]

It should be noted that the technology of the present disclosure may also take the following configurations.

[A1]

a transistor array substrate, including:

a first substrate that includes transistors arranged in an array; and

a second substrate that includes an optical element; in which

the transistors are arranged on a front surface side of the first substrate, and

the second substrate is bonded to a back surface of the first substrate by plasma bonding treatment.

[A2]

The transistor array substrate according to [A1] above, in which

an oxide film on a side of the first substrate and an oxide film on a side of the second substrate are bonded to each other by plasma bonding treatment.

[A3]

The transistor array substrate according to [A1] above, in which

a metal wiring on a side of the first substrate and a metal wiring on a side of the second substrate are bonded to each other by plasma bonding treatment.

[A4]

The transistor array substrate according to [A3] above, in which

a copper wiring on a side of the first substrate and a copper wiring on a side of the second substrate are bonded to each other by plasma bonding treatment.

[A5]

The transistor array substrate according to any one of [A1] to [A4] above, in which

at least one of a microlens and an optical compensation element is formed as the optical element of the second substrate.

[A6]

The transistor array substrate according to [A5] above, in which

the optical compensation element includes a laminated film having a blazed structure.

[A7]

The transistor array substrate according to any one of [A1] to [A4] above, further including

a shading part disposed to be located on the back surface of the transistors is formed as the optical element of the second substrate.

[A8]

The transistor array substrate according to [A7] above, in which

a contact that connects the shading part of the second substrate and a gate electrode of the transistor of the first substrate to each other.

[A9]

The transistor array substrate according to [A8] above, in which

the contact is formed using a via hole provided from a side of a surface opposite to a bonding surface in the second substrate.

[A10]

The transistor array substrate according to [A8] above, in which

the contact is formed using a via hole provided from a side of a bonding surface in the first substrate.

[A11]

The transistor array substrate according to any one of [A7] to [A10] above, in which

the shading part is formed using copper, aluminum, tungsten, or an alloy thereof.

[A12]

The transistor array substrate according to any one of [A7] to [A10] above, in which

the shading part includes a wiring in which copper and a metal different from copper are laminated.

[A13]

The transistor array substrate according to [A12] above, in which

the shading part includes a wiring in which copper and aluminum are laminated.

[A14]

The transistor array substrate according to [A12] above, in which

the shading part include a wiring in which copper and tungsten are laminated.

[A15]

The transistor array substrate according to any one of [A1] to [A15] above, in which

another substrate is further bonded to at least one of a side of the first substrate and a side of the second substrate by plasma bonding treatment.

[B1]

A method of producing a transistor array substrate, including the steps of:

forming transistors arranged in an array on a front surface of a first substrate;

forming a second substrate that includes an optical element; and

bonding, by plasma bonding treatment, the second substrate to a back surface of the first substrate that includes the transistors arranged in an array.

[B2]

The method of producing a transistor array substrate according to [B1] above, further including

bonding an oxide film on a side of the first substrate and an oxide film on a side of the second substrate to each other by plasma bonding treatment.

[B3]

The method of producing a transistor array substrate according to [B1] above, further including

bonding a metal wiring on a side of the first substrate and a metal wiring on a side of the second substrate to each other by plasma bonding treatment.

[B4]

The method of producing a transistor array substrate according to [B3] above, further including

bonding a copper wiring on a side of the first substrate and a copper wiring on a side of the second substrate to each other by plasma bonding treatment.

[B5]

The method of producing a transistor array substrate according to any one of [B1] to [B4] above, further including

forming at least one of a microlens and an optical compensation element as the optical element of the second substrate.

[B6]

The method of producing a transistor array substrate according to [B5] above, further including

forming an optical compensation element that includes a laminated film having a blazed structure.

[B7]

The method of producing a transistor array substrate according to any one of [B1] to [B4] above, further including

forming a shading part disposed to be located on the back surface of the transistors as the optical element of the second substrate.

[B8]

The method of producing a transistor array substrate according to [B7] above, further including

a step of forming a contact that connects the shading part of the second substrate and a gate electrode of the transistor of the first substrate to each other.

[B9]

The method of producing a transistor array substrate according to [B8] above, further including

forming a contact using a via hole provided from a side of a surface opposite to a bonding surface in the second substrate.

[B10]

The method of producing a transistor array substrate according to [B8] above, further including

forming a contact using a via hole provided from a side of a bonding surface in the first substrate.

[B11]

The method of producing a transistor array substrate according to any one of [B7] to [B10] above, further including

forming the shading part using copper, aluminum, tungsten, or an alloy thereof.

[B12]

The method of producing a transistor array substrate according to any one of [B7] to [B10] above, further including

forming the shading part using a wiring in which copper and a metal different from copper are laminated.

[B13]

The method of producing a transistor array substrate according to [B12] above, further including

forming the shading part using a wiring in which copper and aluminum are laminated.

[B14]

The method of producing a transistor array substrate according to [B12] above, further including

forming a shading part using a wiring in which copper and tungsten are laminated.

[C1]

A liquid crystal display device, including:

a transistor array substrate;

a counter substrate disposed to face the transistor array substrate; and

a liquid crystal material layer enclosed between the transistor array substrate and the counter substrate, in which

the transistor array substrate includes a first substrate that includes transistors arranged in an array and a second substrate that includes an optical element,

the transistors are arranged on a front surface side of the first substrate, and

the second substrate is bonded to a back surface of the first substrate by plasma bonding treatment.

[C2]

The liquid crystal display device according to [C1] above, in which

an oxide film on a side of the first substrate and an oxide film on a side of the second substrate are bonded to each other by plasma bonding treatment.

[C3]

The liquid crystal display device according to [C1] above, in which

a metal wiring on a side of the first substrate and a metal wiring on a side of the second substrate are bonded to each other by plasma bonding treatment.

[C4]

The liquid crystal display device according to [C3] above, in which

a copper wiring on a side of the first substrate and a copper wiring on a side of the second substrate are bonded to each other by plasma bonding treatment.

[C5]

The liquid crystal display device according to any one of [C1] to [C4] above, in which

at least one of a microlens and an optical compensation element is formed as the optical element of the second substrate.

[C6]

The liquid crystal display device according to [C5] above, in which

the optical compensation element includes a laminated film having a blazed structure.

[C7]

The liquid crystal display device according to any one of [C1] to [C4] above, further including

a shading part disposed to be located on the back surface of the transistors is formed as the optical element of the second substrate.

[C8]

The liquid crystal display device according to [C7] above, in which

a contact that connects the shading part of the second substrate and a gate electrode of the transistor of the first substrate to each other.

[C9]

The liquid crystal display device according to [C8] above, in which

the contact is formed using a via hole provided from a side of a surface opposite to a bonding surface in the second substrate.

[C10]

The liquid crystal display device according to [C8] above, in which

the contact is formed using a via hole provided from a side of a bonding surface in the first substrate.

[C11]

The liquid crystal display device according to any one of [C7] to [C10] above, in which

the shading part is formed using copper, aluminum, tungsten, or an alloy thereof.

[C12]

The liquid crystal display device according to any one of [C7] to [C10] above, in which

the shading part includes a wiring in which copper and a metal different from copper are laminated.

[C13]

The liquid crystal display device according to [C12] above, in which

the shading part includes a wiring in which copper and aluminum are laminated.

[C14]

The liquid crystal display device according to [C12] above, in which

the shading part includes a wiring in which copper and tungsten are laminated.

[C15]

The liquid crystal display device according to any one of [C1] to [C15] above, in which

another substrate is further bonded to at least one of a side of the first substrate and a side of the second substrate by plasma bonding treatment.

[D1]

An electronic apparatus, including:

a liquid crystal display device including
a transistor array substrate,
a counter substrate disposed to face the transistor array substrate, and
a liquid crystal material layer enclosed between the transistor array substrate and the counter substrate, in which

the transistor array substrate includes a first substrate that includes transistors arranged in an array and a second substrate that includes an optical element,

the transistors are arranged on a front surface side of the first substrate, and

the second substrate is bonded to a back surface of the first substrate by plasma bonding treatment.

[D2]

The electronic apparatus according to [D1] above, in which

an oxide film on a side of the first substrate and an oxide film on a side of the second substrate are bonded to each other by plasma bonding treatment.

[D3]

The electronic apparatus according to [D1] above, in which

a metal wiring on a side of the first substrate and a metal wiring on a side of the second substrate are bonded to each other by plasma bonding treatment.

[D4]

The electronic apparatus according to [D3] above, in which

a copper wiring on a side of the first substrate and a copper wiring on a side of the second substrate are bonded to each other by plasma bonding treatment.

[D5]

The electronic apparatus according to any one of [D1] to [D4] above, in which

at least one of a microlens and an optical compensation element is formed as the optical element of the second substrate.

[D6]

The electronic apparatus according to [D5] above, in which

the optical compensation element includes a laminated film having a blazed structure.

[D7]

The electronic apparatus according to any one of [D1] to [D4] above, in which

a shading part disposed to be located on the back surface of the transistors is formed as the optical element of the second substrate.

[D8]

The electronic apparatus according to [D7] above, further including

a contact that connects the shading part of the second substrate and a gate electrode of the transistor of the first substrate to each other.

[D9]

The electronic apparatus according to [D8] above, in which

the contact is formed using a via hole provided from a side of a surface opposite to a bonding surface in the second substrate.

[D10]

The electronic apparatus according to [D8] above, in which

the contact is formed using a via hole provided from a side of a bonding surface in the first substrate.

[D11]

The electronic apparatus according to any one of [D7] to [D10] above, in which

the shading part is formed using copper, aluminum, tungsten, or an alloy thereof.

[D12]

The electronic apparatus according to any one of [D7] to [D10] above, in which

the shading part includes a wiring in which copper and a metal different from copper are laminated.

[D13]

The electronic apparatus according to [D12] above, in which

the shading part includes a wiring in which copper and aluminum are laminated.

[D14]

The electronic apparatus according to [D12] above, in which

the shading part includes a wiring in which copper and tungsten are laminated.

[D15]

The electronic apparatus according to any one of [D1] to [D15] above, in which

another substrate is further bonded to at least one of a side of the first substrate and a side of the second substrate by plasma bonding treatment,

### REFERENCE SIGNS LIST

1, 1A, 1B, 1C, 1D, 1E liquid crystal display device, 11 horizontal drive circuit, 12 vertical drive circuit, 100, 100A, 100B, 100C, 100D, 100E transistor array substrate, 110 first substrate, 111 support, 112 scan line, 113 transistor (TR), 113A semiconductor material layer, 113B gate electrode, 113C contact, 114 wiring, 115 pixel electrode, 116 wiring layer, 117 oriented film, 118 metal wiring, 119 oxide film, 120 second substrate, 121 support, 122 optical element (microlens), 124A blazed structure, 124B optical element (optical compensation element), 125, 125D, 125E shading part, 128 metal wiring, 129 oxide film, 129A oxide film, 200 counter substrate, 211 support, 212 optical element (microlens), 215 common electrode, 217 oriented film, 300 liquid crystal material layer, 301 liquid crystal molecule, 400 seal part, 700 light source unit, 710 lighting optical system, 720 image control circuit, 730 projection optical system, 740 screen, CS capacitive structure, TR transistor, LS lens shape surface, GR wiring groove, OP1, OP2, OP3 via hole, CT1, CT2 contact

1. A transistor array substrate, comprising:
a first substrate that includes transistors arranged in an array; and
a second substrate that includes an optical element, wherein
the transistors are arranged on a front surface side of the first substrate, and
the second substrate is bonded to a back surface of the first substrate by plasma bonding treatment.

2. The transistor array substrate according to claim 1, wherein
an oxide film on a side of the first substrate and an oxide film on a side of the second substrate are bonded to each other by plasma bonding treatment.

3. The transistor array substrate according to claim 1, wherein
a metal wiring on a side of the first substrate and a metal wiring on a side of the second substrate are bonded to each other by plasma bonding treatment.

4. The transistor array substrate according to claim 3, wherein
a copper wiring on a side of the first substrate and a copper wiring on a side of the second substrate are bonded to each other by plasma bonding treatment.

5. The transistor array substrate according to claim 1, wherein
at least one of a microlens and an optical compensation element is formed as the optical element of the second substrate.

6. The transistor array substrate according to claim 5, wherein
the optical compensation element includes a laminated film having a blazed structure.

7. The transistor array substrate according to claim 1, wherein
a shading part disposed to be located on the back surface of the transistors is formed as the optical element of the second substrate.

8. The transistor array substrate according to claim 7, further comprising
a contact that connects the shading part of the second substrate and a gate electrode of the transistor of the first substrate to each other.

9. The transistor array substrate according to claim 8, wherein
the contact is formed using a via hole provided from a side of a surface opposite to a bonding surface in the second substrate.

10. The transistor array substrate according to claim 8, wherein
the contact is formed using a via hole provided from a side of a bonding surface in the first substrate.

11. The transistor array substrate according to claim 7, wherein
the shading part is formed using copper, aluminum, tungsten, or an alloy thereof.

12. The transistor array substrate according to claim 7, wherein
the shading part includes a wiring in which copper and a metal different from copper are laminated.

13. The transistor array substrate according to claim 12, wherein
the shading part includes a wiring in which copper and aluminum are laminated.

14. The transistor array substrate according to claim 12, wherein
the shading part include a wiring in which copper and tungsten are laminated.

15. The transistor array substrate according to claim 1, wherein
another substrate is further bonded to at least one of a side of the first substrate and a side of the second substrate by plasma bonding treatment.

16. A method of producing a transistor array substrate, comprising the steps of:
forming transistors arranged in an array on a front surface of a first substrate;
forming a second substrate that includes an optical element; and
bonding, by plasma bonding treatment, the second substrate to a back surface of the first substrate that includes the transistors arranged in an array.

17. A liquid crystal display device, comprising:
a transistor array substrate;
a counter substrate disposed to face the transistor array substrate; and
a liquid crystal material layer enclosed between the transistor array substrate and the counter substrate, wherein
the transistor array substrate includes a first substrate that includes transistors arranged in an array and a second substrate that includes an optical element,
the transistors are arranged on a front surface side of the first substrate, and
the second substrate is bonded to a back surface of the first substrate by plasma bonding treatment.

18. An electronic apparatus, comprising:
a liquid crystal display device including
a transistor array substrate,
a counter substrate disposed to face the transistor array substrate, and
a liquid crystal material layer enclosed between the transistor array substrate and the counter substrate, wherein
the transistor array substrate includes a first substrate that includes transistors arranged in an array and a second substrate that includes an optical element,
the transistors are arranged on a front surface side of the first substrate, and
the second substrate is bonded to a back surface of the first substrate by plasma bonding treatment.

19. The electronic apparatus according to claim 18, further comprising
a light source disposed on a side of the second substrate.
